(19) United States
(12) Patent Application Publication
(10) Pub. No.: US 2025/0197186 A1
(43) Pub. Date: Jun. 19, 2025

(54) DRINKING WATER DISPENSING DEVICE INCLUDING OXYGEN NANOBUBBLE GENERATOR AND RELATED METHODS

(71) Applicant: O2 TECHNOLOGIES, LLC, Bradenton, FL (US)

(72) Inventors: Brian N. WRIGHT, Indialantic, FL (US); Stephen GANS, Bradenton, FL (US); Michael GANS, McKinney, TX (US); Dario COLOVIC, Melbourne Beach, FL (US)

(21) Appl. No.: 19/054,505

(22) Filed: Feb. 14, 2025

Related U.S. Application Data
(63) Continuation-in-part of application No. 18/943,744, filed on Nov. 11, 2024.
(60) Provisional application No. 63/606,302, filed on Dec. 5, 2023.

(51) Int. Cl. B67D 1/00; B67D 1/04

(52) U.S. Cl. CPC B67D 1/0043; B67D 1/0014; B67D 1/04; B67D 2001/0092; B67D 2001/0475; B67D 2210/00104

(57) ABSTRACT

A drinking water dispensing device may include a housing, and a water-cooling device carried by the housing for cooling drinking water from a drinking water supply stream having a first pressure. The drinking water dispensing device may also include an oxygen nanobubble generator carried by the housing and coupled downstream from the water-cooling device, and a solid-state oxygen concentrator carried by the housing for supplying an oxygen stream to the oxygen nanobubble generator at a second pressure higher than the first pressure. The drinking water dispensing device may also include a drinking water dispensing outlet carried by the housing and coupled downstream from the oxygen nanobubble generator.

### RELATED APPLICATIONS

The present application is a continuation-in-part application of Ser. No. 18/943,744 filed Nov. 11, 2024, which claims the priority benefit of provisional application Ser. No. 63/606,302 filed on Dec. 5, 2023, the entire contents of both are herein incorporated by reference.

### TECHNICAL FIELD

The present disclosure relates to liquid treatment systems, and, more particularly, to a system and related method for treating a liquid with oxygen nanobubbles.

### BACKGROUND

Nanobubbles have recently gained increased attention due to their unique physicochemical properties. Nanobubbles can be formed using most any gas, and can be injected into a liquid. Due to their size, oxygen nanobubbles, for example, exhibit unique properties that improve numerous physical, chemical, and biological processes. Oxygen nanobubbles are typically 70-120 nanometers in size, and about 2500 times smaller than a single grain of salt. Oxygen nanobubbles remain suspended and disperse to deliver oxygen throughout a liquid.

Oxygen nanobubbles remain stable in the liquid until they interact with surfaces or contaminants, and continue to transfer oxygen to the liquid until the oxygen nanobubbles collapse. Biological additives may be added to the oxygen nanobubbles to provide additional benefits, such as further enhancing soil structure, through aeration enabling water retention, for example, which are beneficial for plant roots. Consequently, there is a need for a liquid treatment system that generates oxygen nanobubbles out in the field and in other applications.

Oxygenated drinking water, that is drinking water with oxygen nanobubbles added, may be beneficial for human consumption, In addition to hydration, oxygenated drinking water may provide health benefits that go beyond those found in traditional drinking water. For example, oxygenated drinking water may aide exercise recovery, flush toxins, and improve alcohol metabolism.

### SUMMARY

A drinking water dispensing device may include a housing, and a water-cooling device carried by the housing for cooling drinking water from a drinking water supply stream having a first pressure. The drinking water dispensing device may also include an oxygen nanobubble generator carried by the housing and coupled downstream from the water-cooling device, and a solid-state oxygen concentrator carried by the housing for supplying an oxygen stream to the oxygen nanobubble generator at a second pressure higher than the first pressure. The drinking water dispensing device may also include a drinking water dispensing outlet carried by the housing and coupled downstream from the oxygen nanobubble generator.

The solid-state oxygen concentrator may be configured to generate the second pressure without a compressor. The solid-state oxygen concentrator may include a concentrator housing and a ceramic core within the concentrator housing and configured to ionize air flowing therethrough, for example.

The drinking water dispensing device may include an oxygen accumulator coupled downstream from the solid-state oxygen concentrator and a pressure regulator coupled downstream from the oxygen accumulator. The drinking water dispensing device may include an oxygen flow meter coupled downstream from the pressure regulator, for example.

The drinking water dispensing device may include a water piping arrangement carried by the housing and extending between the drinking water supply stream and the drinking water dispensing outlet. The drinking water dispensing device may include at least one water treatment magnet associated with the water piping arrangement, for example.

The housing may have a recess therein configured to receive a drinking water container aligned with the drinking water dispensing outlet. The oxygen nanobubble generator may be configured to generate an oxygen concentration within a range of 300-400 million/ml., for example.

The water-cooling device may include a compressor, a condenser, and an evaporator arranged to define a refrigerant-based heat exchanger. The drinking water dispensing device may include a user-operable switch carried by the housing and configured to operate the solid-state oxygen concentrator to dispense cooled oxygenated drinking water via the drinking water dispensing outlet, for example.

A method aspect is directed to a method of dispensing drinking water. The method may include operating an oxygen nanobubble generator carried by a housing and coupled downstream from a water-cooling device carried by the housing for cooling the drinking water from a drinking water supply stream having a first pressure. The method may also include operating a solid-state oxygen concentrator carried by the housing for supplying an oxygen stream to the oxygen nanobubble generator at a second pressure higher than the first pressure so that oxygenated drinking water is provided to a downstream drinking water dispensing outlet carried by the housing.

Operating the solid-state oxygen concentrator may include operating the solid-state oxygen concentrator to generate the second pressure without a compressor. Operating the solid-state oxygen concentrator may include operating the solid-state oxygen concentrator to ionize air flowing through a ceramic core carried by a concentrator housing, for example.

The method may include operating an oxygen accumulator coupled downstream from the solid-state oxygen concentrator, and operating a pressure regulator coupled downstream from the oxygen accumulator. Operating the oxygen nanobubble generator may include operating the oxygen nanobubble generator to generate an oxygen concentration within a range of 300-400 million/ml., for example. Operating the solid-state oxygen concentrator may include operating the solid-state oxygen concentrator to dispense cooled oxygenated drinking water via the water dispensing outlet based upon a user-operable switch carried by the housing.

### BRIEF DESCRIPTION OF THE DRAWINGS

FIG. 1 is a block diagram of an oxygen nanobubble system in which various aspects of the disclosure may be implemented.

FIG. 2 is a side perspective view of a trailer with a portable liquid storage tank and the field portable oxygen nanobubble device illustrated in FIG. 1.

FIG. 3 is a diagram of a fixed liquid storage tank and the field portable oxygen nanobubble device illustrated in FIG. 1.

FIG. 4 is a left-side perspective view of the field portable oxygen nanobubble device illustrated in FIG. 1 with a portion of the housing removed.

FIG. 5 is a partial right-side perspective view of the liquid pump, the porous oxygen injector and the oxygen nanobubble generator illustrated in FIG. 4.

FIG. 6 is a cross-sectional view of the oxygen nanobubble generator and the porous oxygen injector illustrated in FIG. 5.

FIG. 7 is an exploded view of the oxygen nanobubble generator and the porous oxygen injector illustrated in FIG. 5.

FIG. 8 is a schematic block diagram of a treatment device including a nitrogen injector in accordance with another embodiment.

FIG. 9 is a schematic block diagram of a treatment device including nitrogen-based air drying in accordance with another embodiment.

FIG. 10 a schematic diagram of a treatment device including a nitrogen-based regenerative desiccant dryer in accordance with another embodiment.

FIG. 11 is a schematic diagram of a treatment device including a nitrogen-based membrane dryer in accordance with another embodiment.

FIG. 12 is a schematic diagram of a treatment system for concentrated animal feeding operation (CAFO) in accordance with another embodiment.

FIG. 13 is a more detailed schematic block diagram of the oxygen concentrator and oxygen nanobubble generator of FIG. 12.

FIG. 14 is a schematic diagram of a treatment system for surface water in accordance with another embodiment.

FIG. 15 is a more detailed schematic block diagram of the oxygen concentrator and oxygen nanobubble generator of FIG. 14.

FIG. 16 is a schematic diagram of a treatment system for irrigation water in accordance with another embodiment.

FIG. 17 is a more detailed schematic block diagram of the oxygen concentrator and oxygen nanobubble generator of FIG. 16.

FIG. 18 is a schematic diagram of a treatment system for irrigation water in accordance with another embodiment.

FIG. 19 is a schematic diagram of an irrigation water treatment device in accordance with another embodiment.

FIG. 20 is a schematic diagram of a treatment system for swimming pool water in accordance with another embodiment.

FIG. 21 is a schematic diagram of a treatment system for human drinking water in accordance with another embodiment.

FIG. 22 is a diagram of a drinking water dispensing device in accordance with an embodiment.

FIG. 23 is a schematic block diagram of the drinking water dispensing device of FIG. 22.

FIG. 24 is a diagram of a drinking water dispensing device in accordance with another embodiment.

FIG. 25 is a schematic block diagram of the drinking water dispensing device of FIG. 24.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and prime notation and numerals in increments of 100 are used to indicate similar elements in alternative embodiments.

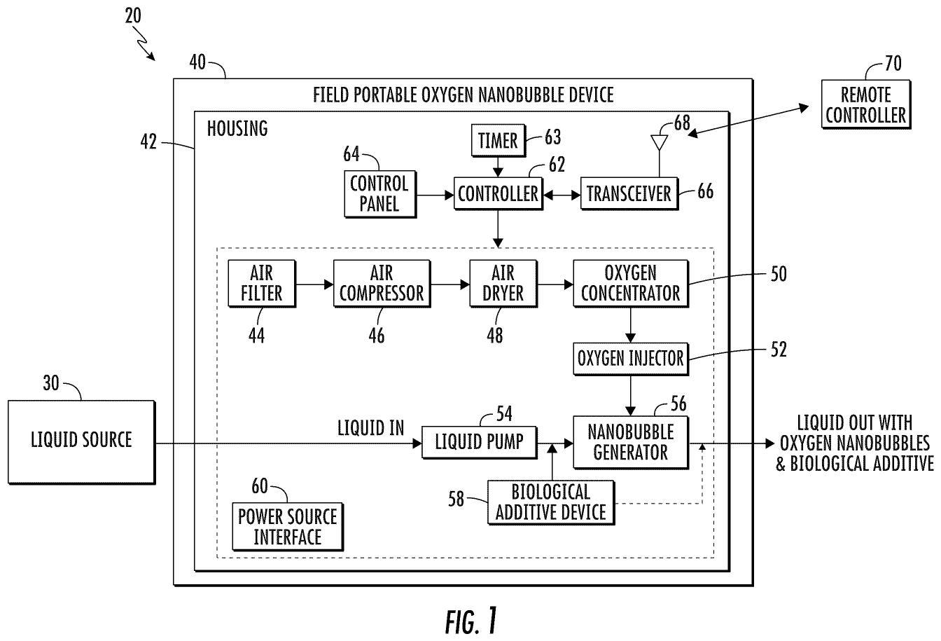

Referring initially to FIG. 1, an oxygen nanobubble system 20 will be described. The oxygen nanobubble system 20 includes a liquid source 30 and a field portable oxygen nanobubble device 40. The liquid source 30 contains liquid to be treated with at least one biological additive and oxygen nanobubbles. The liquid 32 may be well water, for example, or other liquids as described below.

The field portable oxygen nanobubble device 40 is a very efficient way of transferring a gas (i.e., oxygen) into a liquid to create oxygen nanobubbles. The field portable oxygen nanobubble device 40 advantageously creates the oxygen nanobubbles in real-time out in the field using a standard 110v power source that is commonly available. The field portable oxygen nanobubble device 40 may be used for soil aeration, water quality and aquatic health, and concentrated animal feeding operations (CAFO), for example.

Microbial activity influenced by oxygen in the oxygen nanobubbles enhances soil structure, for example. As microbes decompose organic matter, they create binding agents that help to form stable soil aggregates, improving aeration, water infiltration and root growth. Biological additives added to the oxygen nanobubbles provide additional benefits, such as further enhancing soil structure, aeration and water retention, for example, which are beneficial for plant roots. Biological additives include, for example, bacteria, fungi, algae and yeast.

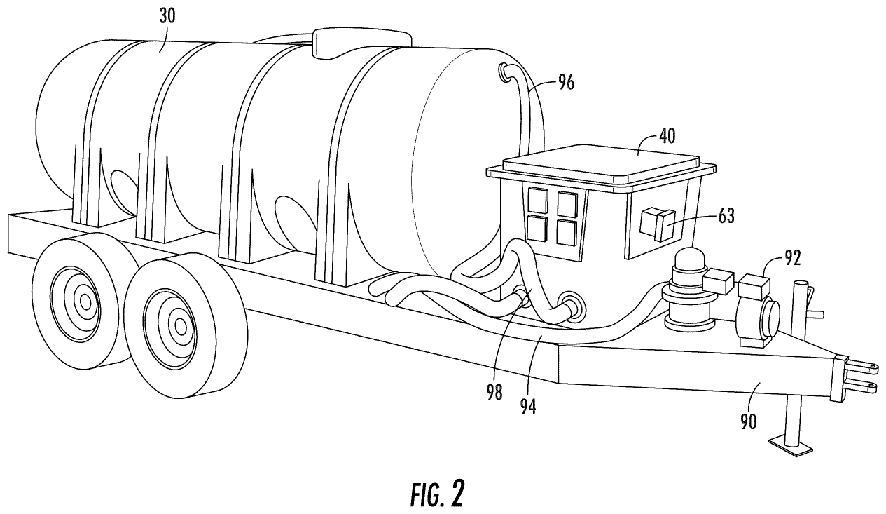

In one embodiment, the field portable oxygen nanobubble device 40 may be trailer mounted, for example, as shown in FIG. 2. A trailer 90 carries the liquid source 30, the field portable oxygen nanobubble device 40 and a gas-powered transfer pump 92. The transfer pump 92 may pump well water via hose 94 into the liquid source 30, which is configured as a holding tank. The field portable oxygen nanobubble device 40 receives the well water via hose 98 and returns the well water with oxygen nanobubbles and a biological additive back to the holding tank via hose 96.

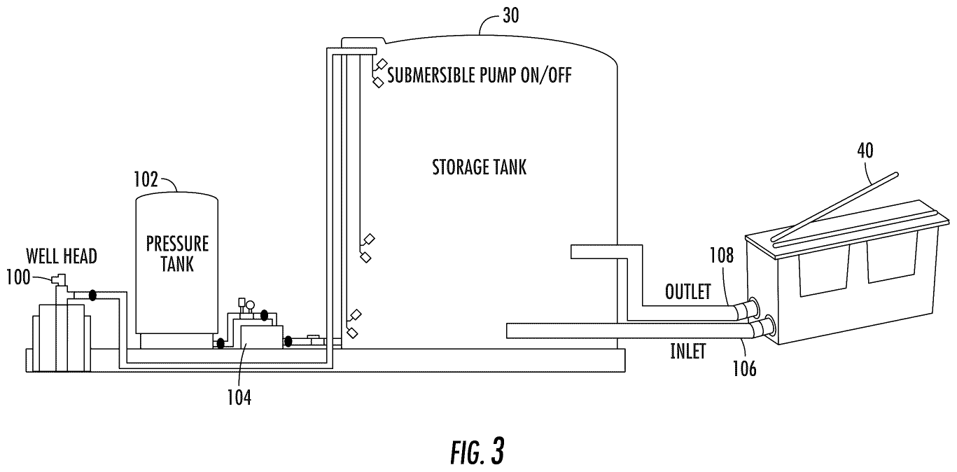

In another embodiment, for example, as shown in FIG. 3, the field portable oxygen nanobubble device 40 may be located next to a non-portable liquid source 30. The non-portable liquid source 30 is configured as a storage tank that is fed with well water by a well head 100 pumping from a well. A booster pump 104 pulls water from the non-portable liquid source or storage tank 30 and keeps the well water in the pressure tank 102 under pressure, such as between 50-75 psi, for example. The field portable oxygen nanobubble device 40 receives the well water from the storage tank 40 via inlet 106 and returns the well water with oxygen nanobubbles and a biological additive back to the storage tank via outlet 108. The field portable oxygen nanobubble device 40 may continuously circulate, adding oxygen nanobubbles to the storage tank 30, which may then be used on demand by the booster pump 104.

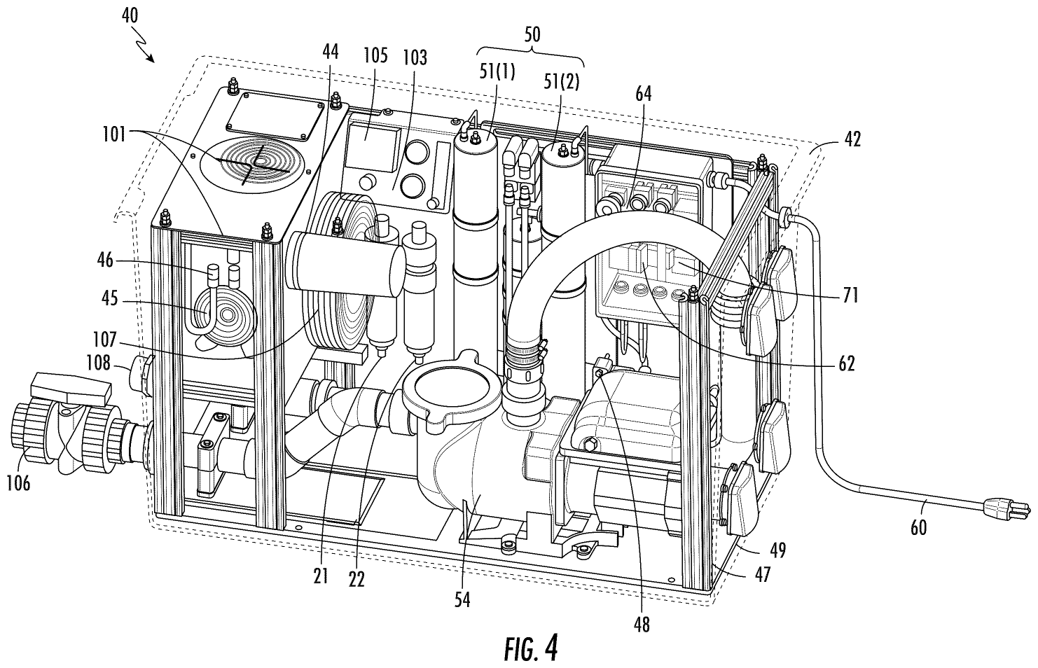

Referring additionally to FIG. 4, the field portable oxygen nanobubble device 40 includes a portable housing 42 that carries a number of components needed to generate the oxygen nanobubbles. An air filter 44 is configured to filter the intake of ambient air into an air compressor 46. The air compressor 46 is coupled downstream from the air filter 44 and is configured to compress the filtered air. A forced air radiator 101 may be coupled to the air compressor 46, for example, to cool the compressed air using finned aluminum coils with air blowing over the surface from a fan. An air dryer 48 is coupled downstream from the air compressor 46 and is configured to remove moisture and filter the compressed air.

An oxygen concentrator 50 is coupled downstream from the air dryer 48 and is configured to separate nitrogen and oxygen. The nitrogen is discharged and the oxygen is provided under pressure to an oxygen receiving tank 53 for storage. The oxygen receiving tank 53 may feed a gas flow control panel 103, which includes a pressure regulator and a flow meter. A controller 105, for example, within gas flow control panel 103, feeds oxygen under pressure to an oxygen injector 52. The oxygen injector 52 is coupled downstream from the oxygen concentrator 50.

A liquid pump 54 is configured to pump the liquid from the liquid source 30 to a nanobubble generator 56. The nanobubble generator 56 is coupled downstream from the liquid pump 54 and the oxygen injector 52 and is configured to generate oxygen nanobubbles within the liquid.

A biological additive device 58 is configured to provide at least one biological additive to the liquid 32. The biological additives may be bacteria, fungi, algae and yeast, for example. The biological additive may be added upstream to the liquid being pumped into the nanobubble generator 56. Alternatively, the biological additive may be added to the liquid with the oxygen nanobubbles being output from the nanobubble generator 56.

The field portable oxygen nanobubble device 40 further includes a power source interface 60. The components in the field portable oxygen nanobubble device 40 advantageously operate from a standard 110V-120V power source supplied with a 15 amp circuit, for example. In some embodiments, solar panels may be used to provide all or some of the power to the power source interface 60.

A controller 62 is configured to control operation of the field portable oxygen nanobubble device 40. The controller 62 may be controlled out in the field using a control panel 64 coupled to a controller 62. Alternatively, the controller 62 may be controlled using a remote controller 70. The field portable oxygen nanobubble device 40 includes a transceiver 66 coupled to the controller 62. An antenna is coupled to the transceiver 68 to wirelessly interface between the transceiver 68 and the remote controller 70.

### Nanobubble Oxygen With Biologics Platform

Referring now additionally to FIGS. 4-7, the field portable oxygen nanobubble device 40 will be described in greater detail. The field portable oxygen nanobubble device 40 allows for operation in residential and commercial applications that may encompass private homeowner associations (HOAs), state regulations as well as federal regulations. Maintaining a power of 110V-120V with a 15 amp circuit while providing a method of circulation (i.e., via liquid pump 54) is a significant design factor. Other design factors may include operational control, low noise, an aesthetically pleasing appearance, and a reliable method of oxygen generation that can be field deployed.

### Details of Design

### 1. Operational Control

Operational control of the field portable oxygen nanobubble device 40 allows for multiple control methods. The field portable oxygen nanobubble device 40 may be designed with three different methods of control.

A first method of control is a standard discrete on/off operation controlled with control buttons on the control panel 64. A second method of control is for applications where the user wants to circulate a volume of water for a set period of time, such as for a mobile tank application. In this method, a digital or mechanical timer 63 is provided external from the housing 42. The timer 63 is coupled to the controller 62, and may allow for one touch timed operations varying from 5 minutes to 4+ hours, for example. Once the timer 63 is engaged, the controller 62 in cooperation with a motor starter 71 will bring the liquid pump 54, air compressor 46, air dryer 48 and oxygen concentrator 50 online automatically and shut them down at the end of the timer cycle. The motor starter 71 includes a thermal limit protection breaker.

A third method of control is via a remote controller 70. The remote controller 70 may be a cell phone running an app that interfaces with the controller 62 via the transceiver 66 and antenna 68. The remote controller 70 may be used for applications that require schedules or external triggers. For example, the field portable oxygen nanobubble device 40 may have a WiFi/Bluetooth smart relay that allows for customization via control of the app. The smart relay allows for remote control, pre-programed schedules, digital triggers, and auxiliary equipment triggers. This is useful if the user wants to control the field portable oxygen nanobubble device 40 during specific periods or have an external device provide a trigger.

### 2. Power Source

The power source interface 60 is advantageously fed with a 110V-120V via a 15 amp circuit. In some applications, the amp circuit may be higher when operating on 110V-120V. The power source 60 allows for use of standard three-prong outlets commonly found near docks, canals, ponds or any body of water that has a standard 120V GFI protected power source. The plug-in electrical cord allows the field portable oxygen nanobubble device 40 to be quickly and easily setup, removed and relocated when necessary.

The field portable oxygen nanobubble device 40 may even be a temporary installation, for example, due to local permitting requirements. Higher voltage power sources may be available, such as 220V, but will most likely require hardwired connections. Use of a higher voltage power source may change the classification of the field portable oxygen nanobubble device 40 from a portable installation to a fixed or permanent installation. Unlike a 110V-120V power source interface 60, a 220V power source may require special permits and/or dedicated switching equipment.

### 3. Field and Outdoor Operation

Operation of the field portable oxygen nanobubble device 40 in humid and dusty environments may benefit from engineering controls designed to allow for reliable operation. Intake of ambient air is controlled by an air filter 44. The air filter 44 may be a multistage air filter assembly. A first stage of the air filter 44 is a filter pre-charger that is a specially designed filter wrap made to extend the service interval of the primary filter when used in very dusty conditions. The filter wrap is made from durable polyester material containing uniform micron openings. The surface of the filter wrap is pretreated with a hydrophobic process designed to prevent water and mud from entering the primary filter. The pre-charger will stop small particles yet add little restriction to the airflow. The pre-charger is cleanable, easily replaceable, and available from automotive stores, for example.

The second stage of the air filter 44 is a large performance filter which incorporates multiple layers of cotton gauze and specially-engineered oil designed for the demands of professional automotive race applications. The performance filter is washable, reusable and will typically last through the life of the field portable oxygen nanobubble device 40. The performance filter is also readily available from automotive stores, for example.

The third stage of the air filter 44 is a standard compressor intake filter with a silencer to reduce noise from the air compressor 46. The compressor intake filter is mounted inside the second stage of the air filter 44.

Downstream from the air filter 44 the filtered air enters a manifold that is plumbed to both intake ports on the air compressor 46. Plumbing to both intake ports allows for a 10-15% performance improvement of the air compressor 46 when operating below 25 psi. This results in lower power and lower heat requirements. The air compressor 46 may be configured as a high efficiency 110V twin head oil-less compressor.

The air compressor 46 may include non-lubed PTFE piston seals, permanently lubricated bearings, UL recognized motor and thermal protectors, a balanced connecting rod assembly, epoxy E-coated wetted components and a twin front mounted nine-blade fan 45 to provide direct cooling. The air compressor 46 may be mounted on isolators to reduce noise and to reduce vibration to adjacent components.

The next step in the process is cooling and drying of the air via the forced air radiator 101, which is coupled to a water separator and filter 21, 22, followed by an air dryer 48 downstream from the air compressor 46. The cooling and drying of the air is in preparation for the oxygen concentrator 50. The oxygen concentrator 50 includes a pair of oxygen sieve beds 51(1), 51(2) and an oxygen receiver 53.

Drying the air via the air dryer 48 is a key step as water moisture entering the oxygen sieve beds 51(1), 51(2) may destroy the zeolite material and cause equipment failure. Without moisture removal the sieve beds 51(1), 51(2) may be clogged and become non-operational within hours.

To prevent this failure and extend the life of the oxygen sieve beds 51(1), 51(2) to their maximum service life, a compact low power pneumatic controlled/electronically activated class 1 regenerative dryer system may be used. This dryer system preps the air to a relative humidity around zero and a dew point of −30 C. or better.

A first stage of the dryer system is a forced air radiator condenser that provides a large surface area of exposed aluminum actively cooled by an electronically controlled (EC) cooling fan 107. A high temperature hose extends from the exhaust port of the compressor motor and enters the radiator assembly. The radiator assembly has a condensation section that allows for liquid water to be separated prior to moving to leaving the radiator assembly. The motor and radiator may be housed inside a small aluminum enclosure with a 10-inch 650 CFM electronically controlled fan 107. The fan 107 pulls fresh air through screen inlets in the platform housing 42 and pushes the air over the motor and radiator and directly out screened exhaust ports of the platform housing 42. The fan 107 can be controlled by the controller 105 which allows temperature triggers for fan speed and data logging of temperature/humidity.

Once the air from the air compressor 46 cools after going through a radiator, it enters a combined filter and water separation element 21, 22, which includes a gravity feed condensed water exit the bottom of the chamber. The bottom of the chamber is cone shaped which leads to a drain port and drain tube. The drain tube is connected to an electrically controlled valve (EDV) that opens and closes based on present timer settings. This valve, once activated, allows the gas pressure in the system to push the water from the first water separator chamber down and out the drain tube and out of the platform housing 42 via an exhaust port in short and quick controlled bursts.

The air exits the water separator through the top and into an oil coalescence filter. The filter may be a 0.01-micron filter, which removes debris and oil from the air before going downstream. The filter may include a filter element that continues to pull water out of the air via condensation and provide a final oil coalescence filter. The water is allowed to drain to the bottom, and like the first water separator, there is a drain point connected to the same electrically controlled valve and exhaust port which automatically purges the water on set intervals. The air at this point has gone through three stages of water separation.

The final setup is a dual chamber sieve material regenerative dryer 48. Air enters into one chamber and pressurizes. The pressure causes the molecular sieve desiccant to separate the last remaining water in the air. The air passes through this sieve bed and exits with a near zero relative humidity and −30° C. or better dew point with high humidity input conditions.

The regenerative part of the dryer occurs when the electrically controlled solenoid valves at the inlet and outlet of the dryer assembly are operated. The valves switches the inlet air from Chamber 1 to Chamber 2 and switches sweep air ports on the outlet side of the chambers from open to close at the same time. When the solenoid valves switch, Chamber 1 goes into Offline mode and Chamber 2 goes into online mode. Chamber 2 includes dry desiccate material and continues to separate the last remaining water from the air. The offline Chamber 1, which is filled with wet desiccate material, is now depressurized to atmosphere and purged with Nitrogen waste gas from the downstream PSA oxygen generator. The depressurization causes water molecules in the desiccate beads to release and be carried away by the vented gas. Further drying of the material is achieve by sweeping over the material with the Nitrogen gas while the chamber is offline.

The nitrogen gas is produced by the downstream PSA oxygen generator. The generator separates nitrogen and oxygen roughly providing 1 part oxygen and 3 parts nitrogen for every cubic foot of air processed. The nitrogen is typically vented to atmosphere as a waste gas in normal PSA equipment. To maintain a low power usage the waste gas is used as the sweep gas for the desiccate dryer. Nitrogen has a very low dew point allowing it to effectively remove moisture from the system. The regenerative dryer assembly cycles between Chamber 1 and 2 continuously to maintain optimal desiccate material.

Now that the air has been dried it is ready to enter the oxygen concentrator 50. The oxygen concentrator 50 includes a pair of oxygen sieve beds 51(1), 51(2) and an oxygen receiving tank 53. When oxygen sieve bed 51(1) is under pressure, the air is separated into nitrogen and oxygen. After about 10 seconds, the oxygen (having a concentration of about 80-95%) in oxygen sieve bed 51(1) is discharged to the oxygen receiving tank 53.

Likewise, when oxygen sieve bed 51(2) is under pressure, the air is separated into nitrogen and oxygen. After about 10 seconds, the oxygen (having a concentration of about 80-95%) in oxygen sieve bed 51(2) is discharged to the oxygen receiving tank 53. The oxygen sieve beds 51(1), 51(2) alternately provide the oxygen to the oxygen receiving tank 53. The oxygen receiving tank 53 is plugged into the controller 62. This allows the controller 62 to adjust the output pressure and the flow of 80-95% oxygen to the oxygen injector 52.

As noted above, the dry air from the air dryer 48 enters an electrically controlled valve manifold where the air is cycled between the oxygen sieve beds 51(1), 51(2) to separate the nitrogen and oxygen. The nitrogen is exhausted back through the regenerative dryer and then continues on to a muffler located into the motor housing which is vented to the outside of the box via the 10″ electrically controlled fan to prevent nitrogen build up inside the box. The oxygen is fed into the oxygen receiving tank 53. The oxygen receiving tank 53 is controlled by a pressure valve running to a flow meter which delivers 80-95% oxygen to the oxygen injector 52.

### 4. Platform Housing/Structure

The platform housing 42 utilizes a robust ultraviolet stable HDPE roto-molded housing which is designed as a dock box. This provides a pleasant aesthetic look that is a benefit for residential docks, ponds and canal applications. Inside the housing 42, an aluminum base plate 49 provides a secure mounting base for the subframe, liquid pump 54 and mounting bolts if the unit is required to be secure to a trailer or skid.

The base plate 49 acts like the circulation skid where the variable speed pump and plumbing is mounted. The variable speed liquid pump 54 may use a standard high efficiency pool pump which allows for easy operation and access for maintenance.

A subframe 47 is bolted to the base plate 49 using tension rods. The tension rods allow for quick installation and removal of the entire oxygen concentrator 50 and the air dryer 48. The ease of access allows for efficient maintenance or switch-out of components or the entire subframe. Removal of the subframe 47 also allows for the base plate 49 and housing 42 to be washed down and cleaned when needed.

### 5. Circulation Skid

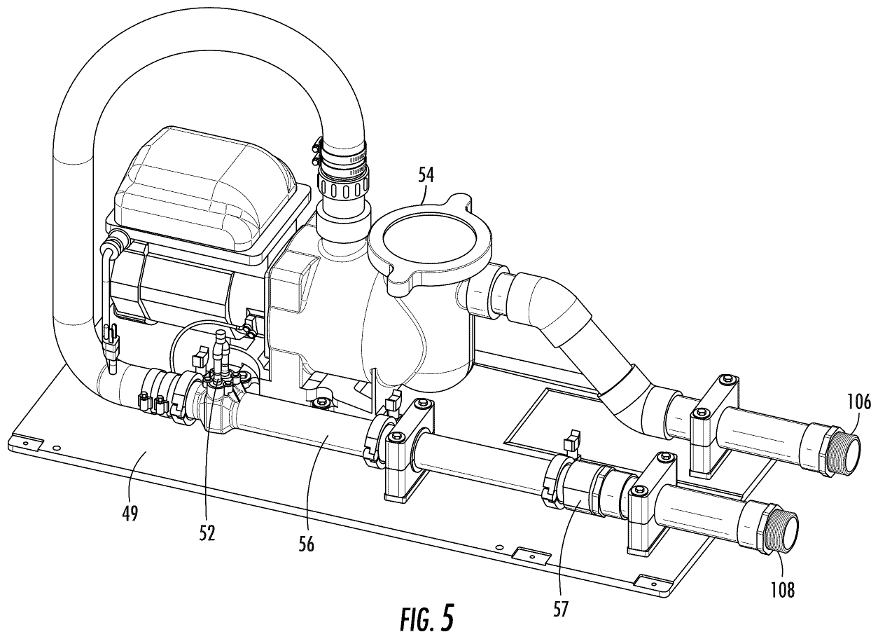

The nanobubble generator 56 is also secured to the aluminum base plate 49, as shown in FIG. 5, which may also be referred to as a skid. Although not shown in FIG. 5, a biological additive device 58 may be secured to the aluminum base plate 49. In one implementation, biological additives from the biological additive device 58 are provided to a biological additive injector 57. The biological additive injector 57 may be at the input of the nanobubble generator 56, as shown, are at an output of the nanobubble generator 56.

The oxygen injector 52 includes a first oxygen injector 52(1) and a second oxygen injector 52(2) side-by side one another. The first and second oxygen injectors 52(1), 52(2) will be generally referenced as oxygen injector 52. The oxygen injector 52 includes a body of porous material 150 that extends across an opening of the nanobubble generator 56. The body of porous material 150 allows liquid 153, as represented by the arrows at the input 120 of the nanobubble generator 56, from the liquid pump 54 to pass through to generate oxygen nanobubbles 122 in the liquid 153.

The body of porous material 150 includes a front side and a back side with an empty space 152 formed therebetween. The front side is facing the input 120 of the nanobubble generator 56. The empty space 152 is configured to receive concentrated oxygen from the oxygen injector 52.

The oxygen injector 52 is configured to inject the concentrated oxygen from the oxygen receiving tank 53 into the empty space 152. The empty space 152 functions as a turbulent chamber which creates a low pressure zone on the backside of the oxygen injector 52. This allows for low-cost oxygen concentrators running at the 5-45 psi.

In some embodiments, the oxygen injectors 51(1), 51(2) are replaceable and/or upgradeable injectors that may be positioned to extend transverse, e.g. 90 degrees, to the flow. This configuration allows for a low-pressure zone behind each injector which lowers the injection pressure. In addition, the nano-pores in the injectors may get plugged over time as will be appreciated by those skilled in the art. The ability to remove and replace parts is therefore advantageous. The oxygen injectors 51(1), 51(2) may be removably secured to the injector housing 118 by any of a number of mechanical fastening arrangements, such as by using bolts, screws, etc. The oxygen injectors 51(1), 51(2) can be made from different materials like titanium, stainless steel, Hastelloy, and Niconel, for example.

The base plate 49 contains the water circulation circuit. This circuit consists of a 2″ PVC inlet that goes into the liquid pump 54, which may be a standard High Efficiency 1.5HP Variable speed pool pump 54. The pool pump 54 can be adjusted from 500 watts to 1500 watts of power based on the operating conditions. The remote automatically turns on and starts up a pre-program priming speed and operating speed once power is applied. The cooling fan on the pump is directly ported via a flexible duct to the outside vent. This uses the built in fan of the liquid pump 54 to draw in fresh air and push it over the cooling fins. The pump outlet goes into a 2″ flexible hose that is curved up and around towards the skid or base plate 49 and into the oxygen injector 52.

The oxygen injector 52 is configured as a two-piece stainless-steel unit with a set of 100 nm Titanium Injectors 52(1), 52(2). The water is pushed over the injectors 52(1), 52(2) which shears off the nano-sized bubbles and pushing them downstream into a hydrodynamic mixing vane. The bubbles exit the vane structure and exit the platform through the outlet pipe.

### Schedule 10 Nanobubble Generator Description

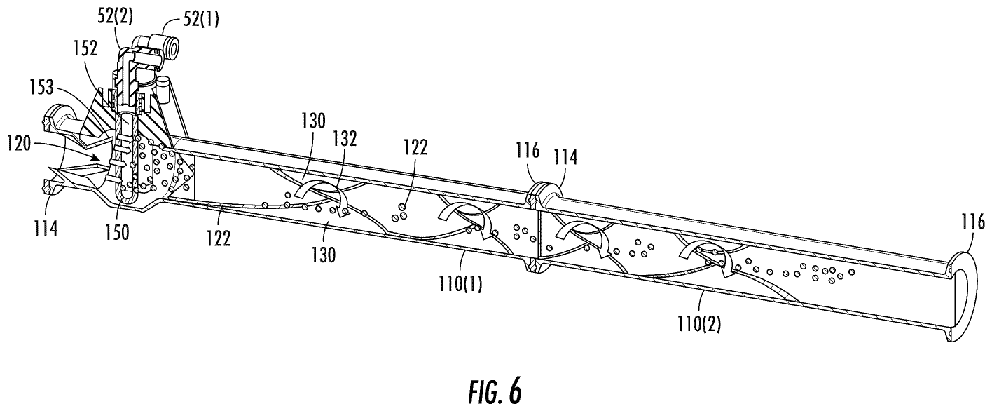

An interior of the nanobubble generator 56 is configured with vane features 130, as shown in FIG. 6, which causes the liquid 153 with the oxygen nanobubbles 152 to spin. The vane features 130 extend to a center of the nanobubble generator 56 which creates a centrifugal force as the liquid 153 with the oxygen nanobubbles 152 spin. The vane features 130 are configured to define a hydrodynamic mixer to spin the liquid 153 with the oxygen nanobubbles 152 traveling through the interior, with the hydrodynamic mixer causing the oxygen nanobubbles 152 to break up into even smaller sizes.

Gas within the nanobubble generator 56 pushes toward a center of the vane features 130 since it is lighter in density. The gas pushes the liquid 153 with the oxygen nanobubbles 152 away from the center, as indicated by arrows 132. The vane features 130 may have a series of sheer features. The shear features may be like a cheese grater or blades, for example. The sheer features cause larger size oxygen nanobubbles 152 to break down into smaller size oxygen nanobubbles 152. The oxygen nanobubbles 152 get smaller as they travel to the end of the nanobubble generator 56. A concentration of the oxygen nanobubbles 152 is within a range of 300-400 million/ml.

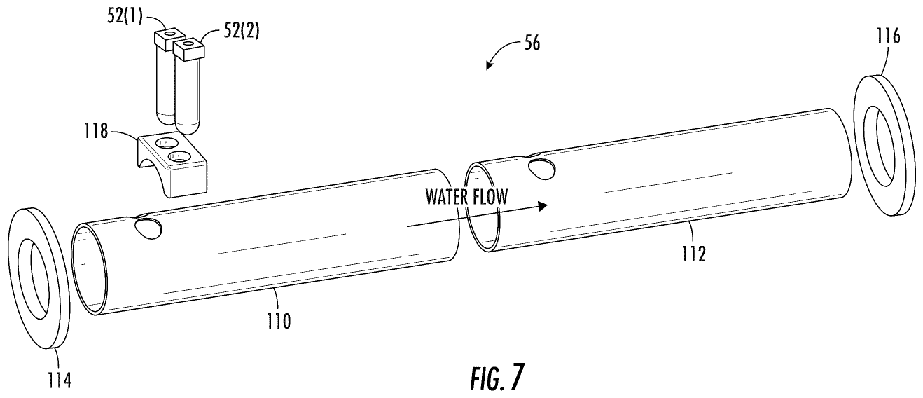

Referring now to FIG. 7, the nanobubble generator 56 includes an outer housing 110 and an inner housing 112 within the outer housing 110. An input flange 114 and an output flange 116 are coupled to the inner and outer housings 112, 110. The first and second oxygen injectors 52(1), 52(2) are positioned in an oxygen injector housing 118 that mounts to the outer housing 110. The first and second oxygen injectors 52(1), 52(2) extend into an opening of the inner and outer housings 112, 110.

Still referring to FIGS. 6 and 7, the nanobubble generator 56 includes a Standard schedule 10 stainless steel outer housing 110 with a Class 150 ANSI flange or sanitary quick clamps 114, 116 or similar, an injector housing 118 for the oxygen injectors 52, and inner housing 112 that provides an internal 3D printed turbulence chamber and hydrodynamic vane structure 130. The injector housing 118 is a solid metal body that is aligned with precut penetrations in the outer pipe and then welded to the exterior of the schedule 10 pipe. The purpose of this housing is to provide the sealing and mounting of the 100 nm metal oxygen injectors 52. These injectors currently are made from 100 nm pore size sintered titanium which is then welded to a solid titanium adapter that provides the seal and locking method to the injector block. The injectors 52 can be made from other materials like stainless steel, Hastelloy and Inconel, for example, and is not limited to titanium. The internal 3D printed housing 112 may be made from stainless steel and is constructed from multiple sections as required by the 3D printing machine bed size. These sections have alignment and nesting features built into the sections that allow for easy assembly and welding.

The internal housing 112 includes two sections; 1) the turbulence chamber and the 2) hydrodynamic vane. The turbulence chamber is a constriction that focuses the water flow over the injectors and creates a high velocity zone, and thus a high turbulence zone across the injector 52. This is key to creating a low-pressure zone across the injectors 52 which allows the operator to inject low pressure oxygen or gas which leads to lower power usage and oxygen compressor requirements. This chamber can be tuned or adjusted during manufacturing to a customer specific flow conditions to maintain low pressure injectors 52 even with low water flow rates. For example, a 4″ assembly running at 27 psi inlet pressure may only require a 9 psi gas pressure for 50 lpm at 900 GPM. This low pressure is key to maintain low operating costs and support equipment requirements.

After the turbulence chamber comes the hydrodynamic vane 130. The vane pitch, surface texture/shape and length can be optimized or change depending on the customer requirements. The nanobubble generator 56 operates when water is pushed via a pump, gravity or forward motion into the injector turbulence chamber. The water shears off the nano-sized bubbles off the surface of the injector down across the hydrodynamic mixing vane. There are two forms of nanobubble generation. Active and passive. The active method is the stripping of the nanobubbles off the surface of the injector. The passive method is the generation of the Nanobubbles by shear when passing down the hydrodynamic mixer. Shear forces will cause large bubbles to break down and form smaller nanobubbles. During this process some of the bubbles expire and transfer their oxygen (if using oxygen) into the water, thus increasing the DO of the water. The remaining nano-bubbles stay suspended in the water and will expire at a later date. At that point they will transfer their oxygen to the body of water.

### Use-Case Discussion

1. Confined Animal Operations. A. Pigs, Cows, Chickens, Turkeys, Rabbits, Fish etc. B. Remediation of animal manure/wastewater ponds.
2. Lake, Pond, Canal Remediation (break down of Muck) reducing the need for or as a replacement to dredging. A. Remote site applications.
3. Onsite Reactor for state-of-the-art onsite facility and long-term water storage.
4. Crop Irrigation applications for Pivots, drip irrigation (flood, micro jet, overhead, and subsurface irrigation along with side dressing applications and foliar sprays).

### 1. Confined Animal Operations

Confined Animal farms are very common across the world. Typically, water is pulled from wells and pressurized and supplied to the animals for hydration. A simple application of the nanobubble technology is to fill a local reservoir or tank located near the animal shelter. For an example chicken farm application this storage tank could be in an auxiliary storage room at the individual chicken house. The tank would be automatically filled with standard float valves which maintain water level. A portable nanobubble oxygen system is plumbed into the tank circulating the water continuously adding billions of nanobubbles to the tank. The tank is then connected to a pressure pump which transfer the water to each of the chicken water feeder lines. This has several advantages.

CAFOs: Applying a high concentration of oxygen nanobubbles with or without a high concentration of beneficial bacteria in a vegetative state or spore state to confined animal feeding operations provides:

Improved Waste Management: Vegetative bacteria can assist in breaking down organic matter present in animal waste more efficiently. By accelerating the decomposition process, they can reduce the volume of waste and associated odors.

Reduced Pathogens: Beneficial bacteria can outcompete harmful pathogens commonly found in animal waste. They help maintain a healthier microbial balance, potentially reducing the risk of disease transmission among the animals and improving overall hygiene within the facility.

Odor Control: The breakdown of organic matter by these bacteria can significantly decrease the release of foul-smelling gases, thereby improving air quality in and around the CAFO.

Environmental Impact: By promoting the decomposition of organic waste, the application of beneficial bacteria can help in reducing the environmental impact of CAFOs. This can lead to decreased contamination of soil and water, mitigating potential pollution issues.

Healthier Animals: A more balanced microbial environment can positively impact the overall health of the animals. When potentially harmful bacteria are kept in check by beneficial species, it can contribute to improved animal health and welfare.

Nanobubble technology has the potential to offer several benefits in confined animal feeding operations (CAFOs), which are agricultural facilities where large numbers of animals are raised in relatively small, controlled spaces. Here are some of the advantages of using nanobubble technology in CAFOs:

Improved Water Quality: Nanobubbles can enhance water quality by increasing dissolved oxygen levels. In CAFOs, maintaining good water quality is important for the health of animals. Adequate dissolved oxygen levels can help reduce stress, improve immune function, and promote overall well-being.

Pathogen Control: The enhanced oxidation capabilities of nanobubbles can help control pathogens in water sources within CAFOs. This is critical for preventing the spread of diseases among the animals and reducing the need for chemical disinfection.

Reduced Ammonia Levels: Nanobubbles can promote the conversion of ammonia (NH3) to nitrate (NO3—) through biological processes. This can reduce the concentration of ammonia in the water, which is a common issue in CAFOs due to animal waste. Lower ammonia levels are beneficial for animal health and the environment.

Improved Nutrient Management: Nanobubbles can facilitate the efficient delivery of nutrients in water, such as vitamins and minerals, to the animals. This can help ensure that the animals receive the necessary nutrients for growth and health.

Increased Oxygen in Manure Ponds: CAFOs often store animal waste in manure ponds. The addition of nanobubbles to these ponds can increase dissolved oxygen levels, which can support the growth of beneficial microorganisms that break down organic matter and reduce odors.

Reduction in Chemical Usage: By improving water quality, nanobubble technology can reduce the need for chemical treatments to control pathogens and enhance water quality. This can lead to cost savings and reduced environmental impact.

Stress Reduction: Improved water quality, aeration, and oxygenation can help reduce stress among animals in CAFOs. Reduced stress can lead to better animal growth rates and lower mortality rates.

Environmental Benefits: Nanobubble technology can contribute to more environmentally friendly CAFO practices by mitigating water pollution, reducing nutrient runoff, and lowering the environmental impact of these operations.

Compliance with Regulations: Using nanobubble technology to improve water quality and reduce the environmental footprint of CAFOs can help operators comply with regulations related to water quality, environmental impact, and animal welfare.

Efficient Resource Use: By optimizing the use of water and nutrients, nanobubble technology can enhance resource efficiency in CAFOs, making operations more sustainable and cost-effective.

It may be important to note that the practical application and benefits of nanobubble technology in CAFOs may vary depending on the specific facility, animal species, and operational practices. Additionally, proper maintenance and monitoring of the technology may be helpful to realize these benefits effectively and sustainably in CAFOs.

Confined animal feeding operations (CAFOs) can benefit from the measurement and improvement of various variables to enhance productivity, animal welfare, and environmental sustainability. Key variables to consider include:

Feed Efficiency: Monitoring the efficiency of feed conversion is crucial. This involves tracking how much feed is required to produce a unit of animal product (e.g., meat, milk, or eggs). Improving feed efficiency reduces production costs and minimizes resource waste.

Growth Rates: Measuring and optimizing the growth rates of animals is important for productivity. Faster growth often means quicker turnover, reducing the time and resources required to raise animals to market weight.

Water Consumption: Efficient water use is important for both animal health and operational cost savings. Monitoring water consumption can help identify issues such as leaks or overuse, which can be costly and environmentally detrimental.

Health and Disease Incidence: Regular health assessments and monitoring disease incidence are vital. Early detection and intervention can prevent the spread of diseases and minimize the use of antibiotics, which is increasingly important due to concerns about antibiotic resistance.

Mortality Rates: Reducing mortality rates is a key productivity indicator. High mortality rates result in economic losses and can signal health or management issues within the operation.

Feed Quality and Composition: Ensuring the quality and composition of animal feed is important for optimal growth and productivity. Regular testing of feed ingredients and final feed formulations can help maintain nutritional balance.

Manure Management: Efficient management of manure and waste products is critical for both environmental compliance and resource use. Measuring and optimizing manure management techniques can minimize the environmental impact.

Air Quality: Maintaining good air quality within CAFOs is crucial for animal health and productivity. Monitoring variables like ammonia levels, dust content, and temperature can help create a healthier environment.

Animal Welfare: Tracking animal welfare indicators, such as space allocation, behavioral patterns, and stress levels, is not only ethically important but can also have a direct impact on animal health and productivity.

Environmental Impact: Monitoring and minimizing the environmental impact of CAFOs is increasingly important. Variables to consider include nutrient runoff, greenhouse gas emissions, and water usage.

Economic Efficiency: CAFOs may continually assess their financial performance, including revenue, costs, and profitability. This involves managing input costs, optimizing operational practices, and staying informed about market trends.

Regulatory Compliance: Ensuring compliance with local, regional, and national regulations may be important. Regular monitoring and documentation of relevant variables are key to staying compliant.

Energy Efficiency: Reducing energy consumption can result in cost savings and minimize the environmental impact of CAFO operations. Monitoring energy use and adopting energy-efficient technologies can help achieve this.

Record Keeping: Effective record keeping is important for tracking and analyzing the above variables. Well-maintained records provide a historical perspective and enable data-driven decision-making for productivity improvement.

By consistently measuring and improving these variables, CAFOs can enhance productivity, reduce waste, improve animal welfare, and operate in a more sustainable and cost-effective manner.

### 2. Muck Remediation in Canals or Lakes

A common problem is organic build up in canals or ponds which commonly referred to as muck. This is a result of the organic input from the environment (soils, plant leaves, fertilizer runoff, grass clippings, pollen grains, etc.) being greater than the biological decay/breakdown process contained within the lake. The biological decay/breakdown process requires two primary components; the population and diversity of the microorganisms and the oxygen concentration to support them. As the body of water becomes unbalanced, sediment begins to build over time resulting in a dense thick muck layer. The BOD (biological oxygen demand) of this muck layer becomes so great that the natural flora body cannot support the decay/breakdown process. This impacts the health of the body of water including low oxygen level, reduced water clarity and release of harmful gases. Muck can also contribute to growth and sustainment of harmful algae blooms, which can be toxic to aquatic life and humans. Common methods to reduce and remove muck range from pressurized air aeration, surface aerators like fountains, and mechanical remove of the muck via shovel, rollers, rakes and suction dredging.

Mechanical methods can be expensive and are only a temporary solution as the unbalanced equation of organic inputs (soils, plant leaves, grass clippings, pollen grains, nutrient and industrial runoff, etc. vs decay rate typically remains unbalanced. Additional methods of aeration using pressurized air pumped to an air stone or bubbler device below the water surface are inefficient with a typical Oxygen transfer efficiency of 2-5%. and only provide location DO increase which can take years to provide meaningful results.

To break this unbalanced equation a compact portable nanobubble generator with an outdoor rate oxygen system can be used to circulate body of water. This system can provide greater then 80% oxygen transfer efficiency while introducing two forms of gas Dissolved Oxygen and Nanobubbles. The addition of the dissolved oxygen and nanobubbles allows the body of water to kick start the natural decay/breakdown process. The extra oxygen in the water column can also support additional beneficial microbes which are introduced to the outlet of machine to accelerate the process populating and supporting the indigenous populations. Microorganisms are known to be effective in bioremediation efforts to clean up soil contaminated with pollutants or toxic substances. They can help break down and detoxify certain contaminants. Microbes are known to improve the health of aquatic ecosystems by removing excess sediment and pollutants that might be harming aquatic life. Oxygenated microbes can restore natural habitats and improve water quality.

For locations with very high BOD demands from years of build-up, additional Oxygen Nanobubble circulation units can be added temporarily to a lake or canal to accelerate the timetable and then removed as required. The unique design of the equipment allows for stackable or scalable circulation and oxygen injection at a given location without infrastructure.

For remote applications where onsite power is limited a mobile solar panel cart can be used with a single nanobubble oxygen circulation unit for remediation of a lake, pond or canal.

3. Onsite Reactor for State-of-the-Art Onsite Facility and long-term water storage:

O2 Technologies mobile O2 tank system “onsite reactor”—ensures high concentrations of vegetative bacteria applied to the targeted source—(Agriculture, CAFO's, Remediation). The onsite reactor consists of a portable low power oxygen nanobubble platform with onboard circulation mounted to a mobile trailer with a 1000-gallon tank. The tank is filled from a local water source, typically this is a well or pumped water source. The tank is then circulated with the nanobubble platform that fully saturated the water with Dissolved Oxygen and billions of oxygen nanobubbles. The nanobubbles act as an oxygen storage system which allows the water to be stored for up to a year without a significant loss of dissolved oxygen as the oxygen stored in the nanobubbles continuously replenishes the water over time if the water is not agitated. This allows for collection and storage of water during low cost or abundant water periods and a method of long-term storage. The water then can be directly used as an onsite reactor or transfer to small reactors for various parallel activities throughout the farm.

Active and Metabolically Engaged: vegetative bacteria are in their active, growing state. They are metabolically engaged, performing cellular functions, growing, reproducing, and actively metabolizing nutrients.

Faster Action: Vegetative bacteria are already in an active growth phase, so they can immediately start metabolizing and building or degrading the target source. Spores, on the other hand, need time to germinate before they become active, which can delay the microbial activity processes.

Efficiency: With higher concentrations of vegetative bacteria, there's a greater population ready to start breaking down the source material. This larger number of active organisms can result in quicker and more efficient bioremediation.

Increased Viability: Vegetative bacteria are often more resilient compared to spores, which might face challenges in harsh environmental conditions. Higher concentrations of vegetative bacteria ensure a greater likelihood of survival and activity in adverse conditions.

Adaptability: Vegetative bacteria can adapt more readily to changing environmental conditions and variations in the source material, potentially enhancing their ability to break down contaminants.

In the Onsite bio-reactor formulations, the concentrated microorganisms are formulated to the most optimum concentrations for targeted effectiveness. These concentrations will continue to be expressed along with an exponential increase in the indigenous microbial populations or populations that perform supportive roles in building the natural flora when mixed or infused with dissolved oxygen/nanobubble processed water in their targeted locations. The Unique Area of Population Enhancement is prevalent in all Industry sectors and applications that 02 Technologies processes will be introduced.

A Unique Area: The State, the Viability, the Condition, the Status, of the microorganisms when introduced into the targeted environment by being premixed as an inoculant and sprayed, and or infused through any form of irrigation will achieve the most viable and effective populations for both the introduced and indigenous due to being premixed with the treated dissolved oxygen and nanobubbles. The only way to achieve this level of microbial stability is to premix with dissolved oxygen/nanobubble or infuse through irrigation populating both the introduced and the indigenous microorganism positively impacting the natural flora.

The microorganism population growth when formulated with dissolved oxygen/nanobubble processes is the unique area, understanding that this microbial population activity is not readily attainable without the oxygen/nanobubble process. The effectiveness of either the higher populations or the supportive populations of the natural flora is indicative of the more vigorous, more complete, more sustainable results shown and compared to traditional practices and methods of applying and stimulating biologicals.

Unique is the incorporation of the microbial formulas with highly oxygenated water placing the microorganisms in the most conducive position to exponentially impact the targeted profile and populate to maximize the beneficial effects of the formulated and indigenous microbials. This function also presents population growth of the indigenous microorganisms found in the targeted areas where the treatment is sprayed or irrigation is being introduced.

The effectiveness of the microorganisms when formulated with dissolved oxygen/nanobubble treated water sources, reduces the nutrient requirements of both conventional and organic farming due to soil mining and more efficient nutrient uptake. In addition, this reduces reliance on other control product requirements, and builds a healthy soil profile with greater water holding capacity and improved Cation Exchange Capacity (CEC).

The oxygen treated water can be supplied from any of the 02 technologies Application Processes, the Mobile Treatment Unit Applications, the Irrigation Treatment Unit Applications, the Confined Animal feeding Operations Unit Applications, and the Remediation Treatment Unit Applications. All treatment application units can have a water source from wells, holding ponds, and or canals.

### 4. Crop Irrigation Applications for Pivots, Drip Irrigation, Etc.:

Crop irrigation takes many forms from massive pump stations, large circular or linear pivots, or drip irrigation to flood irrigation to name a few. The oxygen nanobubble platform can be used for all these applications and its unique low power on board oxygen system is key to successful field execution. The ability to have a portable, low power and stackable (adding additional units as required) system allows the operating complete flexibility to optimize for weekly or daily operational needs. In addition, the equipment can be easily relocated in the case of serious weather events like flooding, tornados or hurricanes.

Adding oxygen to irrigation water, a practice known as oxygenation or oxygen supplementation, can offer several benefits for crop production, especially in hydroponic and controlled environment agriculture (CEA) systems. The advantages of oxygenating irrigation water include:

Improved Root Health: Oxygen-rich water promotes better root health and development. Well-oxygenated roots can absorb nutrients more efficiently, leading to enhanced plant growth and crop yields.

Enhanced Nutrient Uptake: Oxygenation can increase the availability and mobility of nutrients in the root zone. This results in improved nutrient uptake by plants, which can optimize their growth and overall health.

Reduced Risk of Root Diseases: Well-oxygenated root zones are less prone to the growth of anaerobic microorganisms that cause root diseases. This reduces the risk of root rot and other pathogenic issues, contributing to healthier plants.

Prevention of Waterlogging: Oxygenation can help prevent waterlogging or saturation of the root zone. Waterlogged soil or growing media can deprive roots of oxygen, leading to stress and reduced growth. Oxygen supplementation mitigates this risk.

Uniform Water Distribution: Oxygenated water is often better at maintaining uniform moisture distribution within the root zone. This ensures that all plants receive adequate water and nutrients, reducing the risk of overwatering or underwatering.

Increased Drought Tolerance: Plants grown in oxygen-rich environments are more resilient to periods of drought or reduced irrigation. The enhanced root system developed in well-oxygenated conditions can help plants access water even when it is scarce.

Stress Resistance: Oxygen supplementation can improve the overall stress resistance of plants. This is particularly valuable in controlled environments where crops may be subjected to fluctuating environmental conditions.

Optimized Growing Conditions: In hydroponic and soilless systems, oxygenation ensures that plant roots are provided with an optimal environment for growth. This leads to faster growth rates, shorter crop cycles, and potentially increased yields.

Enhanced Microbial Activity: Beneficial microorganisms in the root zone require oxygen for their growth and activity. Oxygenation can support the presence of these beneficial microbes, which can aid in nutrient cycling and disease suppression.

Environmental Control: Oxygenation can help maintain consistent conditions within the root zone, supporting the overall control of the growing environment.

Reduced Fertilizer Waste: Improved nutrient uptake means less waste of expensive fertilizers. Oxygen supplementation ensures that nutrients are efficiently utilized by plants rather than being lost to leaching.

Energy Savings: Although the energy required for oxygenation should be considered, the potential for enhanced growth and productivity can offset these costs through increased crop yields.

It is important to note that the effectiveness of oxygenation depends on factors such as the specific crop, the cultural practices, and the environmental conditions. Consistent use of the oxygen nanobubble process is necessary to achieve the expected desired results. Overall, adding oxygen to irrigation water is a valuable tool in modern agriculture, especially in systems where comprehensive control over growing conditions is crucial.

### Additional Notes on Oxygen Nanobubbles in Agriculture Application

Improved Oxygen Dissolution: Nanobubbles are extremely small gas bubbles, typically less than 100 nanometers in diameter. These tiny bubbles have a very high surface area, allowing for more efficient oxygen dissolution in water. In agriculture, this can be beneficial for aerating water and providing oxygen to plant roots in hydroponic and aquaponic systems. Oxygen-rich water promotes better root health and nutrient uptake.

Enhanced Nutrient Delivery: Nano bubble technology can be used to deliver nutrients to plant roots more effectively. When nutrients are encapsulated within nanobubbles, they can be transported to the root zone more efficiently. This can lead to increased nutrient availability for plants and improved growth. Water Quality Improvement: Nanobubbles can help improve water quality by enhancing the oxidation of organic matter, pathogens, and contaminants in water. This can be particularly valuable in aquaculture and irrigation systems, where maintaining water quality is crucial for plant and animal health.

Reduced Algae and Biofilm Formation: Nanobubbles can disrupt the growth of algae and the formation of biofilms in irrigation systems. This helps maintain clean water lines, reduces clogging, and ensures a more consistent water supply to plants.

Enhanced Pesticide and Fertilizer Efficiency: When nanobubbles are used in combination with pesticides or fertilizers, they can increase the efficiency of these inputs. The nanobubbles can help disperse and deliver these substances more uniformly, reducing waste and improving the effectiveness of treatments.

Reduced Water Usage: By improving the efficiency of water and nutrient delivery to plants, nano bubble technology can help reduce water usage in agriculture. This is especially important in regions facing water scarcity and drought conditions.

Sustainable Agriculture: Nano bubble technology can contribute to more sustainable agriculture practices by reducing the need for excess water, chemicals, and fertilizers. It aligns with the goals of precision agriculture and environmentally friendly farming.

Disease and Pest Control: Nanobubbles can be used to treat water sources for disease control and pest management in aquaculture and hydroponic systems. The technology can help reduce the risk of diseases affecting crops and aquatic organisms.

Improved Crop Yields: Overall, the combination of improved oxygen delivery, better nutrient utilization, and disease prevention can lead to increased crop yields in a controlled agricultural environment.

### Oxygen Is the Key

A key component of the field portable oxygen nanobubble device 40 is the low power on board oxygen system. Oxygen plays a crucial role in microbial growth and propagation in soil, and its benefits can be summarized as follows.

Aerobic Respiration: Oxygen is important for the process of aerobic respiration, which is the primary energy source for many soil microbes. During aerobic respiration, microbes break down organic matter to produce energy, carbon dioxide, and water. This process is highly efficient and allows microbes to generate more energy compared to anaerobic respiration.

Nutrient Availability: Oxygen helps release nutrients from organic matter and minerals in the soil, making them more readily available for microbial uptake. Microbes require various nutrients for growth, and the presence of oxygen supports the decomposition of organic materials, releasing these important nutrients.

Detoxification: Oxygen assists in the breakdown of toxic compounds and chemicals in the soil. Microbes can utilize oxygen to metabolize and detoxify substances that would otherwise inhibit their growth, making the soil environment more favorable for microbial propagation.

Competitive Advantage: Aerobic microbes thrive in oxygen-rich environments and can outcompete anaerobic microorganisms in such conditions. This competition can limit the growth of pathogenic or undesirable microbes in the soil, contributing to a healthier and more balanced microbial community.

Organic Matter Decomposition: Oxygen is crucial for the efficient decomposition of organic matter in the soil. Microbes break down plant residues, dead organisms, and other organic materials in the presence of oxygen, releasing carbon dioxide and nutrients that contribute to soil fertility.

Soil Structure Improvement: Microbial activity influenced by oxygen can enhance soil structure. As microbes decompose organic matter, they create binding agents that help to form stable soil aggregates, improving aeration, water infiltration, and root growth.

Disease Suppression: Some aerobic bacteria and fungi produce antibiotics and other compounds that can suppress the growth of soil-borne pathogens. A well-aerated soil with active aerobic microbes can have a natural defense mechanism against certain diseases.

Nutrient Cycling: Microbes play a crucial role in nutrient cycling in the soil, and oxygen availability facilitates their ability to cycle and recycle important elements such as carbon, nitrogen, and phosphorus, benefiting both soil health and plant growth.

In summary, oxygen is important for microbial growth and propagation in soil due to its role in aerobic respiration, nutrient availability, detoxification, competitive advantage, organic matter decomposition, soil structure improvement, disease suppression, and nutrient cycling. Adequate oxygen levels in the soil create a favorable environment for beneficial microbes and contribute to overall soil health and fertility.

Oxygen has a significant impact on microbiological growth, and this impact can vary depending on whether microbes are aerobic (requiring oxygen) or anaerobic (thriving in the absence of oxygen). Below is an overview of how oxygen affects microbiological growth.

### Aerobic Microbes

Favorable Environment: Oxygen is important for the growth and metabolism of aerobic microbes. These microorganisms thrive in oxygen-rich environments because they use aerobic respiration to generate energy from organic compounds. The presence of oxygen allows them to efficiently extract energy from substrates, promoting their growth.

Fast Growth: Aerobic microbes tend to grow more rapidly than their anaerobic counterparts. This is due to the higher energy yield of aerobic respiration, which enables them to replicate and divide faster.

Nutrient Utilization: Oxygen facilitates the breakdown of complex organic molecules and the release of nutrients. Aerobic microbes can utilize these nutrients more effectively for their growth and reproduction.

Competitive Advantage: In oxygen-rich conditions, aerobic microbes can outcompete anaerobic microbes, potentially limiting the growth of undesirable or pathogenic microorganisms.

### Anaerobic Microbes

Tolerate Low Oxygen or Lack of Oxygen: Anaerobic microbes are adapted to environments with low oxygen levels or completely devoid of oxygen. They can grow in niches where oxygen is scarce, such as deep in the soil, sediments, or within the human digestive system.

Slower Growth: Anaerobic metabolism typically yields less energy compared to aerobic respiration. As a result, anaerobic microbes may grow more slowly and have a reduced capacity to compete with aerobic counterparts in oxygen-rich environments.

Unique Metabolism: Anaerobic microbes have developed unique metabolic pathways to thrive without oxygen. They can utilize alternative electron acceptors, such as nitrate or sulfate, to carry out anaerobic respiration.

In summary, the presence or absence of oxygen has a profound impact on microbiological growth. Aerobic microbes require oxygen for efficient growth and metabolism, while anaerobic microbes are adapted to environments with limited or no oxygen and have evolved alternative strategies for growth. The interplay between aerobic and anaerobic microbes in various ecosystems is a fundamental factor influencing microbial community dynamics and the overall biogeochemical processes that occur in those environments.

### Biologics High-Level Overview

### Bacillus Species

Bacillus species (commonly referred to as Bacillus spp.) are a group of beneficial bacteria that can have several positive effects on soil and plants. These bacteria are known for their plant growth-promoting and disease-suppressing properties. Listed below are some of the key benefits of Bacillus species in soil and for plant health.

Biological Control of Plant Pathogens: Many Bacillus species produce antibiotics and antifungal compounds that can inhibit the growth of plant pathogens. When applied to soil or plants, these bacteria can help protect crops from diseases caused by harmful fungi and bacteria.

Induced Systemic Resistance: Bacillus species can stimulate a plant's natural defense mechanisms, leading to enhanced resistance against various pathogens. This process, known as induced systemic resistance (ISR), can reduce the need for chemical pesticides.

Nutrient Mobilization: Some Bacillus strains have the ability to solubilize nutrients such as phosphorus and micronutrients in the soil. This makes these nutrients more available to plants, improving their nutrient uptake and overall health.

Nitrogen Fixation: Certain Bacillus species are capable of fixing atmospheric nitrogen into a plant-available form. This can enhance the nitrogen content of the soil and promote plant growth without the need for synthetic fertilizers.

Phytohormone Production: Bacillus spp. can produce plant growth-promoting hormones, like indole-3-acetic acid (IAA). These hormones can stimulate root development, leading to increased nutrient and water uptake.

Improved Soil Structure: Some Bacillus species, through their production of extracellular polymers, can contribute to the formation of stable soil aggregates. This enhances soil structure, aeration, and water retention, which is beneficial for plant roots.

Degrading Organic Matter: Bacillus bacteria are involved in the decomposition of organic matter in the soil, which helps release nutrients and humic substances, improving soil fertility.

Tolerance to Environmental Stress: Bacillus spp. are often resilient and can tolerate various environmental stresses, such as drought, high salinity, and extreme temperatures. When applied to plants, they can enhance the plants' ability to withstand adverse conditions.

Bioremediation: Some Bacillus strains have been used in bioremediation efforts to clean up soil contaminated with pollutants or toxic substances. They can help break down and detoxify certain contaminants.

Seed Coating and Biofertilizers: Bacillus-based products are commonly used as seed coatings or incorporated into biofertilizers. This allows for a convenient and eco-friendly way to introduce beneficial bacteria to the root zone, promoting plant health from the early stages of growth.

Incorporating Bacillus species into agriculture and horticulture practices can reduce the reliance on chemical inputs, improve soil health, enhance crop yields, and promote sustainable farming. Their versatility and benefits make them a valuable component of integrated pest management and sustainable agricultural systems.

### Pseudomonas

Pseudomonas is a diverse genus of bacteria that includes many species, some of which are well-known for their beneficial effects on soil and plant health. These bacteria are commonly used in agriculture and horticulture due to their plant growth-promoting and disease-suppressing properties. Below are some of the key benefits of Pseudomonas in soil and for plant health.

Biological Control of Plant Pathogens: Pseudomonas species produce various antibiotics and antifungal compounds that can inhibit the growth of plant pathogens. When applied to soil or plants, they can help protect crops from diseases caused by harmful fungi and bacteria.

Induced Systemic Resistance: Some Pseudomonas strains can induce systemic resistance in plants. This process enhances the plant's innate defense mechanisms, making them more resistant to a wide range of pathogens.

Nutrient Solubilization: Pseudomonas bacteria have the ability to solubilize nutrients, such as phosphorus and iron, in the soil. This increases the availability of these nutrients to plants, promoting better growth and development.

Biological Nitrogen Fixation: Certain Pseudomonas species can fix atmospheric nitrogen into a plant-usable form. This reduces the need for synthetic nitrogen fertilizers and contributes to improved plant growth and soil fertility.

Phytohormone Production: Pseudomonas can produce plant growth-promoting hormones, such as auxins and cytokinins. These hormones can stimulate root development, leading to improved nutrient and water uptake.

Biofilm Formation: Some Pseudomonas strains can form biofilms on plant roots. These biofilms protect plants from root pathogens and can enhance nutrient absorption and water retention.

Biodegradation of Organic Matter: Pseudomonas bacteria are involved in the decomposition of organic matter in the soil. This process releases nutrients and organic compounds, improving soil fertility and structure.

Enhanced Stress Tolerance: Pseudomonas spp. can help plants withstand environmental stressors, such as drought, salinity, and certain pollutants, by producing protective compounds and promoting stress resistance.

Bioremediation: Some Pseudomonas species are used in bioremediation efforts to clean up contaminated soils. They can break down and detoxify a wide range of pollutants and toxic compounds.

Seed Coating and Biofertilizers: Pseudomonas-based products are applied as seed coatings or incorporated into biofertilizers, providing a convenient way to introduce beneficial bacteria to the root zone, thereby promoting plant health from the early stages of growth.

Promotion of Mycorrhizal Associations: Some Pseudomonas strains can enhance mycorrhizal associations, which are beneficial symbiotic relationships between plants and mycorrhizal fungi. These associations can improve nutrient uptake and overall plant health.

Pseudomonas bacteria are versatile and offer a wide range of benefits to soil and plant health. They are a valuable tool in sustainable agriculture and can reduce the reliance on chemical inputs while improving crop yields and promoting ecological balance in the soil ecosystem.

### Additional Listing of Features and Advantages

1. The Oxygen Nanobubble Process produces an oxygen rich water capable of generating high concentrations of aerobic microorganisms.
2. The Oxygen Nanobubble rich water applied through any irrigation systems enriches the indigenous microbial concentrations in the soils where applied.
3. The Oxygen Nanobubble rich water applied through any irrigation systems continues to enrich the microbial concentrations in the soils where applied, initiating the natural flora mechanisms to populate the indigenous to their preferred ecosystem concentrations.
4. The Oxygen Nanobubble rich water applied through any irrigation systems continues to facilitate the aerobic microbial growth which eventually controls the ecosystems aerobic dominance managing the soil health.
5. The Oxygen Nanobubble rich water applied through

any irrigation systems continues to facilitate the aerobic microbial growth which decomposes organic matter creating binding agents that form soil aggregates, improving soil aeration.
6. The Oxygen Nanobubble rich water applied through any irrigation systems continues to facilitate the aerobic microbial growth which decomposes organic matter creating binding agents that form soil aggregates, improving water infiltration.
7. The Oxygen Nanobubble rich water applied through any irrigation systems continues to facilitate the aerobic microbial growth which decomposes organic matter creating binding agents that form soil aggregates, improving water retention.
8. The Oxygen Nanobubble rich water applied through any irrigation systems continues to facilitate the aerobic microbial growth which decomposes organic matter creating binding agents that form soil aggregates, improving root growth
9. The Oxygen Nanobubble rich water applied through any irrigation systems continues to facilitate the aerobic microbial growth which decomposes organic matter creating binding agents that form soil aggregates, improving soil structure.
10. The Oxygen Nanobubble rich water applied through any irrigation systems continues to facilitate the aerobic microbial growth leading to well oxygenated roots that can absorb nutrients more efficiently enhancing plant growth and crop yields.
11. The Oxygen Nanobubble rich water applied through any irrigation systems continues to facilitate the aerobic microbial growth and the availability and mobility of nutrients in the root zone resulting in improved nutrient uptake.
12. The Oxygen Nanobubble rich water applied through any irrigation systems continues to facilitate the aerobic microbial growth and less facilitating to anaerobic microorganisms, reducing the risk of root diseases and other pathogenic issues, the aerobic microorganisms producing antibiotics and other exudates that can suppress the growth of soil borne pathogens, contributing to healthier plants.
13. The Oxygen Nanobubble rich water applied through irrigation are more resilient to periods of drought or reduced irrigation due to the enhanced root system that can help plants access water even when it is scarce.
14. The Oxygen Nanobubble rich water used in hydroponic and soilless systems ensures that the plant roots are provided with an optimal environment for growth, leading to faster growth rates, shorter crop cycles, and potentially increased yields.
15. When Oxygen rich water is used in combination with pesticides and or nutrients, they can increase the efficiency of these inputs, the nanobubbles help disperse and deliver these substances more uniformly improving effectiveness.
16. The Oxygen Nanobubble rich water can disrupt the growth of algae and the formation of biofilms in the lines of the irrigation systems.
17. The Oxygen Nanobubble technology by improving the efficiency of the water usage and nutrient delivery contributes to more sustainable agricultural practices by reducing the needs for excess water, chemicals and fertilizers.
18. The potential sources of irrigation from surface water ponds, lakes, canals can be treated with the Oxygen Nanobubble rich technology producing an oxygen aerobic microorganism rich source for pathogen free irrigation to agriculture, aquaculture, hydroponics and other plant growing facilities.
19. The Oxygen Nanobubble rich water introduced into CAFO waste holding lagoons facilitates the aerobic microbial growth which decomposes the organic matter reducing the volume of waste to manage thus reducing nutrient runoff.
20. The Oxygen Nanobubble rich water introduced into CAFO waste holding lagoons facilitates the aerobic microbial growth which decomposes the organic matter significantly decreasing the release of foul smelling gases like ammonia, thereby improving air quality in and around CAFO's.
21. The Oxygen Nanobubble technology reduces the environmental footprint of the CAFO's and can help with operators complying with regulations related to water quality, environmental impacts, and animal welfare.
22. The Oxygen Nanobubble treated water by increasing the dissolved oxygen levels can improve the drinking water quality to the CAFO's, building the immune systems, reducing stress and promoting overall better health of the animal.
23. The enhanced oxidation capabilities of the Nanobubbles can help control pathogens in water sources within the CAFO's reducing the need for chemical disinfection.
24. Oxygen rich water with Nanobubbles facilitates the efficient delivery of nutrients, such as vitamins and minerals in water to the animals.
25. The Oxygen Nanobubble technology reduces the mortality rates by improving the water quality and controlling the gases exposed to the confined animals.
26. The Oxygen rich Nanobubble technology improves the health of aquatic ecosystems by improving the water quality.
27. The Oxygen rich Nanobubble technology improves the health of aquatic ecosystems by reducing (Biological Oxygen Demand) BOD's and (Chemical Oxygen Demand) COD's.
28. The Oxygen rich Nanobubble technology with aerobic microorganisms maintain and improve the health of aquatic ecosystems by removing excess sediment and pollutants disturbing aquatic life.
29. The Oxygen rich Nanobubble technology with aerobic microorganisms degrades nitrogenous waste that is toxic to aquatic life like ammonia, nitrates, and nitrites improving the health of aquatic ecosystem.
30. The Oxygen rich Nanobubble technology with aerobic microorganisms improves the digestion (gut integrity) of the aquatic life leading to faster body weight gain by the aquatic life.
31. The Oxygen rich Nanobubble technology with aerobic microorganisms will enhance gut immunity and reduce mortality.
32. The Oxygen rich Nanobubble technology will produce the most viable and effective populations for both the introduced aerobic microorganisms and the indigenous populations maintaining the aquatic ecosystem.
33. The Oxygen rich Nanobubble technology assists in the aerobic microorganism population that breaks down toxic chemical compounds in soils and waters, detoxifying substances and compounds that would otherwise continue to contaminate the soils and waters rendering the contaminated sites dangerous and useless.
34. The Oxygen Nanobubble rich technology facilitates the breakdown of complex organic molecules and the release of nutrients that aerobic microorganisms utilize more effectively for their growth and reproduction.
35. The “Rich Oxygen Juice” forms a growth chamber for the introduced microorganisms as well as the indigenous microorganisms once sent through irrigation or applied to the soil developing a “Synergistic Path” of aerobic dominance maintaining soil health and or water quality.

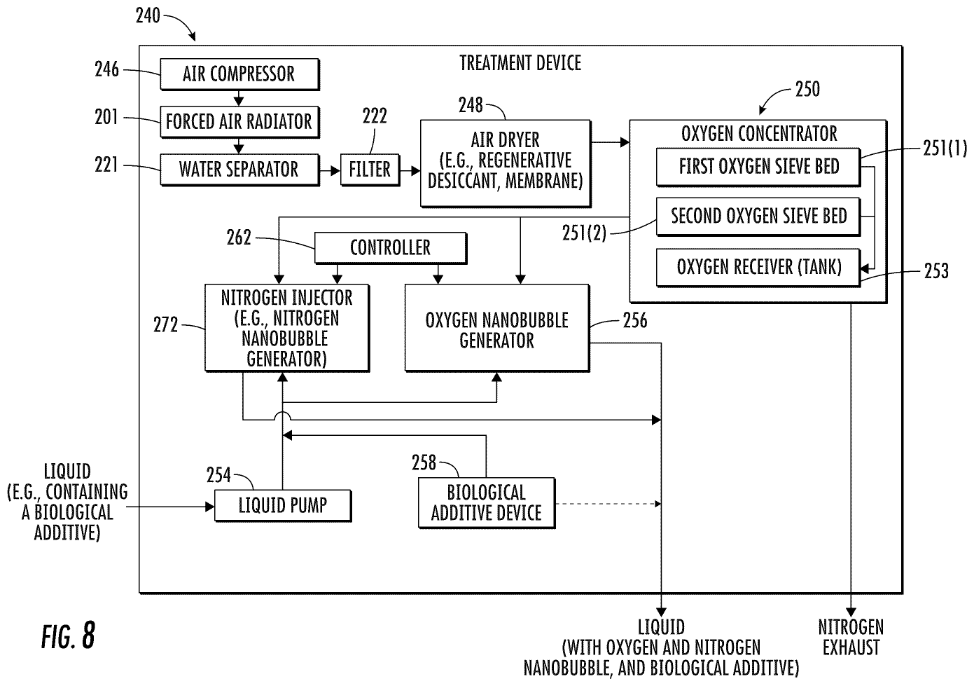

Referring now to FIG. 8, an exemplary implementation of a treatment device 240 for a liquid, for example, that may contain one or more biological additives, will be described. Alternatively or additionally, a biological additive device 258 may be used, as will be described in further detail below.

The treatment device 240 includes an air compressor 246 that generates compressed air. An air dryer 248 is downstream from the air compressor 246. The air dryer 248 may be in the form of a regenerative desiccant dryer, for example, or a membrane dryer. A forced air radiator 201, water separator 221 and a filter 222 are between the air compressor 246 and the air dryer 248.

The treatment device 240 also includes an oxygen concentrator 250 similar to that described above and that separates nitrogen and oxygen from the compressed air. More particularly, the oxygen concentrator 250 includes first and second oxygen sieve beds 251(1), 251(2) to separate the nitrogen and oxygen from the compressed air, as described above. An oxygen receiver 253 receives the concentrated oxygen from the first and second oxygen sieve beds 251(1), 251(2), as described above.

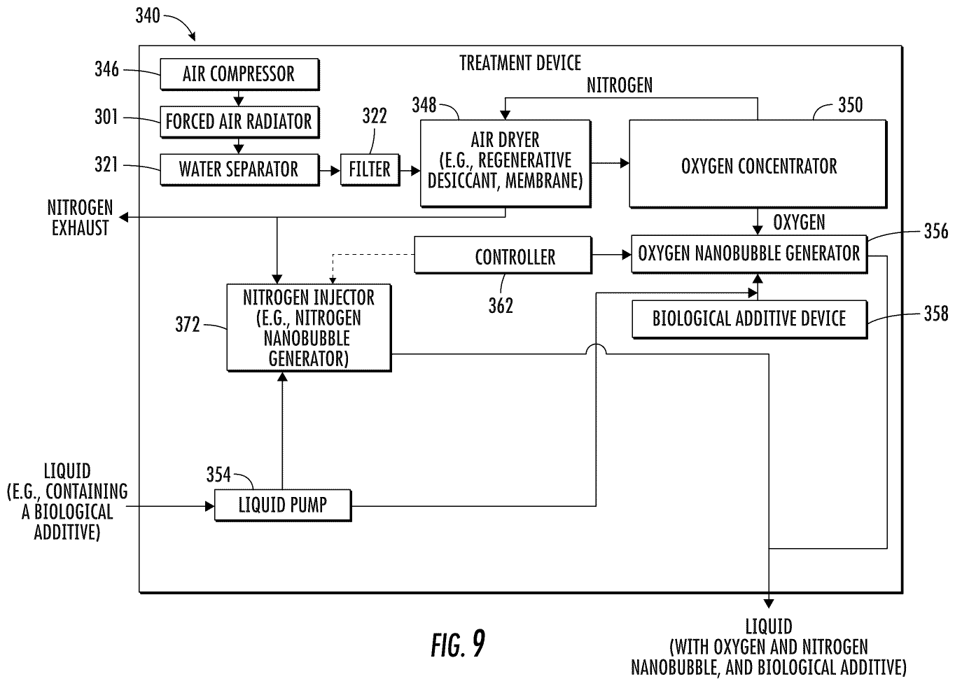

The oxygen concentrator 250 outputs nitrogen. For example, as illustrated in FIG. 9, the nitrogen output is received by the air dryer 248.

A nitrogen injector 272 is coupled downstream from the oxygen concentrator 250. The nitrogen injector 272 injects nitrogen into the liquid. The nitrogen injector 272 may be in the form of a nitrogen nanobubble generator that generates nitrogen nanobubbles within the liquid. A controller 262 cooperates with the nitrogen injector 272 to control an amount of nitrogen injected into the liquid.

An oxygen nanobubble generator 256 is coupled downstream from the oxygen concentrator 250. The oxygen nanobubble generator 256, similar to the nanobubble generators described above, generates oxygen nanobubbles within the liquid. More particularly, a liquid pump 254 operates to pump the liquid through the oxygen nanobubble generator 256, and the oxygen nanobubbles may be generated as the liquid is pumped through the oxygen nanobubble generator. A biological additive device 258, as described above, may be coupled to the oxygen nanobubble generator 256 to permit addition of one or more biological additive into the liquid. The controller 262 cooperates with the oxygen nanobubble generator 256 to also control an amount of oxygen injected into the liquid.

A corresponding method aspect is directed to a method for liquid treatment. The method includes generating compressed air using an air compressor 246 and concentrating oxygen and separating nitrogen and oxygen from the compressed air using an oxygen concentrator 250. The method also includes injecting nitrogen into the liquid using a nitrogen injector 272 coupled downstream from the oxygen concentrator 250 and generating oxygen nanobubbles within the liquid using an oxygen nanobubble generator 256 coupled downstream from the oxygen concentrator.

Injecting nitrogen using the nitrogen injector 272 may include generating nitrogen nanobubbles within the liquid using a nitrogen nanobubble generator 256, for example. The method may include using a controller 262 to control an amount of nitrogen injected into the liquid. Using the controller 262 may include using the controller to cooperate with the oxygen nanobubble generator 256 to control an amount of oxygen injected into the liquid, for example.

The method may include drying the compressed air using an air dryer 248 coupled downstream from the air compressor 246. Drying the compressed air may include drying the compressed air using nitrogen received from the oxygen concentrator 250, for example.

The method may further include pumping the liquid through the oxygen nanobubble generator 256 using a liquid pump 254. The method may also include supplying at least one biological additive within liquid, for example.

Referring now to FIG. 9, another exemplary implementation of a treatment device 340 for a liquid, for example, that may contain one or more biological additives, will be described. Alternatively or additionally, a biological additive device 358 may be used, as will be described in further detail below.

The treatment device 340 includes an air compressor 346 the generates compressed air. An air dryer 348 is downstream from the air compressor 346. The air dryer 348 may be in the form of a regenerative desiccant dryer, for example, or a membrane dryer. A forced air radiator 301, water separator 321 and a filter 322 are between the air compressor 346 and the air dryer 348.

The treatment device 340 also includes an oxygen concentrator 350 similar to that described above and coupled downstream from the air dryer 348. The oxygen concentrator 350 separates nitrogen and oxygen from the compressed dry air. The oxygen concentrator 350 outputs the nitrogen to the air dryer 348.

An oxygen nanobubble generator 356 is coupled downstream from the oxygen concentrator 350. The oxygen nanobubble generator 356, similar to the nanobubble generators described above, generates oxygen nanobubbles within the liquid. More particularly, a liquid pump 354 operates to pump the liquid through the oxygen nanobubble generator 356, and the oxygen nanobubbles may be generated as the liquid is pumped through the oxygen nanobubble generator. A biological additive device 358, as described above, may be coupled to the oxygen nanobubble generator 356 to permit addition of one or more biological additives into the liquid.

A nitrogen injector 372 may be downstream from the air dryer 348. The nitrogen injector 372 may inject the nitrogen from the air dryer 348 into the liquid. The nitrogen injector 372 may be in the form of a nitrogen nanobubble generator that generates nitrogen nanobubbles within the liquid. In other words, in addition to oxygen nanobubbles injected into the liquid, nitrogen nanobubbles may also be injected into the liquid. As will be appreciated by those skilled in the art, the nitrogen nanobubbles may stimulate bacteria within the liquid to be treated, and thus provide increased treatment responses.

A controller 362 cooperates with the oxygen nanobubble generator to control an amount of oxygen injected into the liquid. The controller 362 may be similar to the controller described above. The controller 362 may, in some embodiments, alternatively or additionally, cooperate with the nitrogen injector 372 to control an amount of nitrogen within the liquid.

A corresponding method aspect is directed to a method for liquid treatment. The method includes generating compressed air using an air compressor 346. The method also includes drying the compressed air using an air dryer 348 coupled downstream from the air compressor 346 and separating nitrogen and oxygen from the compressed dry air and outputting the nitrogen to the air dryer using an oxygen concentrator 350 coupled downstream from the air dryer. The method further includes generating oxygen nanobubbles within the liquid using an oxygen nanobubble generator 356 coupled downstream from the oxygen concentrator 350.

Drying the compressed air using the air dryer 348 may include drying the compressed air using a regenerative desiccant dryer, for example. Drying the compressed air using the air dryer 348 may include drying the compressed air using a membrane dryer, for example.

The method may include injecting nitrogen from the air dryer 348 into the liquid using a nitrogen injector downstream from the air dryer. Injecting nitrogen from the air dryer 348 into the liquid using the nitrogen injector may include generating nitrogen nanobubbles within the liquid using a nitrogen nanobubble generator 372, for example.

The method may include controlling an amount of oxygen injected into the liquid using a controller 362 cooperating with the oxygen nanobubble generator. The method may include pumping the liquid through the oxygen nanobubble generator 372 using a liquid pump 354, for example. The method may also include supplying at least one biological additive 358 within the liquid.

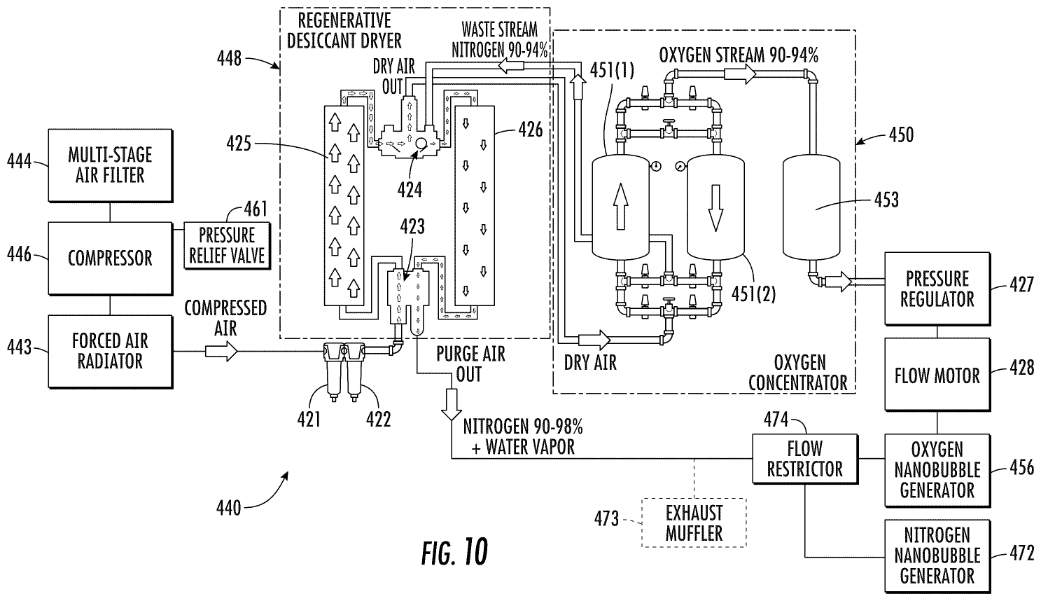

Referring now to FIG. 10, further details of an exemplary treatment device 440 with oxygen and nitrogen liquid injection along with nitrogen dryer input will now be described. As will be appreciated by those skilled in the art, the treatment device 440 operates similarly to the treatment devices 240, 340 described above.

An air filter 444 filters the intake of ambient air into the air compressor 446. A pressure relief valve 461 is coupled to the air compressor 446. A forced air radiator 443 coupled to the air compressor 446 provides compressed air to a water separator 421 and particle filter 422 to remove water and any particulate matter from the compressed air, respectively. The filtered compressed air is provided to an air dryer 448, and more particularly, a valve 423 of the air dryer. The air dryer 448 is illustratively in the form of a regenerative desiccant dryer.

As a regenerative desiccant dryer 448, an online tower 425 (drying) has an input that is coupled to the valve 423 and provides drying of the compressed air. Another valve 424 is coupled the output of the online tower 425 and provides an output of dry air. The regenerative desiccant dryer 448 also includes an offline tower 426 (regenerating) having an input coupled to the valve 424 and an output coupled to the valve 423.

Dry air from the regenerative desiccant dryer 448, and more particularly, dry air output from the valve 424 is output to the oxygen concentrator 450. As described above, the oxygen concentrator 450 includes first and second oxygen sieve beds 451(1), 451(2) and oxygen receiver or oxygen buffer tank 453. The oxygen sieve beds 451(1), 451(2) alternately provide the oxygen to the oxygen buffer tank 453.

Oxygen from the oxygen concentrator 450 is output to a pressure regulator 427 and on to a downstream flow meter 428 before being input to the oxygen nanobubble generator 456. A waste stream from the oxygen concentrator 450, for example, including about 90%-94% nitrogen is output and provided as an input to the regenerative desiccant dryer 448. More particularly, the nitrogen-rich waste stream from the oxygen concentrator 450 is input to the valve 424 of the regenerative desiccant dryer. The nitrogen-rich waste stream is output via the valve 423 as purge air out. The waste stream output from the regenerative desiccant dryer 448, which includes 90%-98% nitrogen and water vapor, is provided to a flow restrictor 474 and to a nitrogen nanobubble generator 472 (i.e., nitrogen injector). In some embodiments, for example, where a nitrogen nanobubble generator 472 is not used, the nitrogen-rich waste stream may be output via an exhaust muffler 473.

As will be appreciated by those skilled in the art, the art, it may be desirable to inject nitrogen into a liquid stream as certain bacteria respond or accept nitrogen to react. The nitrogen for these bacteria may not occur naturally, or there may not be enough nitrogen to activate these bacteria. Similarly to oxygen nanobubble, nitrogen nanobubbles may stimulate certain species of bacteria that use nitrogen, which may be unavailable or insufficient in the liquid or water being treated.

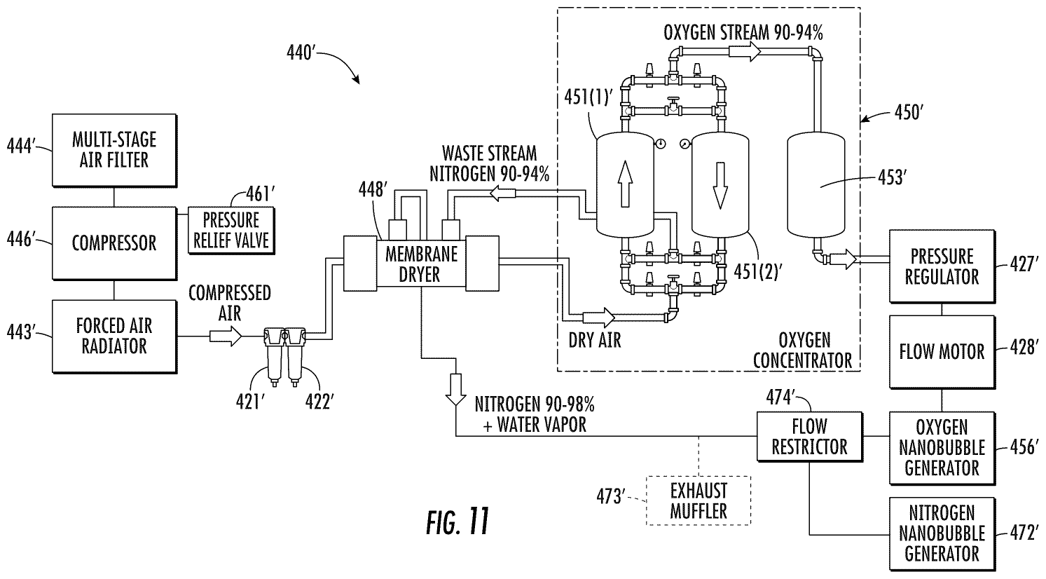

Referring now to FIG. 11, details of another exemplary treatment device 440′ with oxygen and nitrogen liquid injection along with nitrogen dryer input will now be described. In the present embodiment, the air dryer is in the form of a membrane dryer 448′. Other than the membrane dryer 448′, the components and operation the treatment device 440′ is similar to that of the treatment device 440 described above.

More particularly, the air filter 444′ filters the intake of ambient air into the air compressor 446′. The pressure relief valve 461′ is coupled to the air compressor 446′. A forced air radiator 443′ coupled to the air compressor 446′ provides compressed air to a water separator 421′ and particle filter 422′ to remove water and any particulate matter from the compressed air, respectively. The filtered compressed air is provided to the membrane air dryer 448′.

As will be appreciated by those skilled in the art, with respect to the membrane air dryer 448′, the filtered compressed air to be dried is passed over a membrane (e.g., in the form of small tubes) that has a relatively high affinity for water vapor. The water vapor builds on the membrane and travels to a low pressure, side. A dry cover gas is flowed across the low pressure side and absorbs the water on the membrane. After absorbing the water, the cover gas is discharged or taken.

Dry air from membrane dryer 448′ is output to the oxygen concentrator 450′. As described above, the oxygen concentrator 450′ includes first and second oxygen sieve beds 451(1)′, 451(2)40 and oxygen receiver or oxygen buffer tank 453′. The oxygen sieve beds 451(1)′, 451(2)′ alternately provide the oxygen to the oxygen buffer tank 453′.

Oxygen from the oxygen concentrator 450′ is output to a pressure regulator 427′ and on to a downstream flow meter 428′ before being input to the oxygen nanobubble generator 456′. A waste stream from the oxygen concentrator 450′, for example, including about 90%-94% nitrogen is output and provided as an input to the membrane dryer 448′. More particularly, the nitrogen-rich waste stream from the oxygen concentrator 450′ may be provided to the membrane dryer 448′ as the cover gas. The waste stream output (e.g., the cover gas) from the membrane dryer 448′, which includes 90%-98% nitrogen and water vapor, is provided to a flow restrictor 474′ and to a nitrogen nanobubble generator 472′ (i.e., nitrogen injector). In some embodiments, for example, where a nitrogen nanobubble generator 472′ is not used, the nitrogen-rich waste stream may be output via an exhaust muffler 473′. Similarly to the nitrogen injection embodiment described above, the present embodiment using the membrane dryer 448′ may be particularly useful for generating an increased reaction response or acceptance for certain bacteria, the response of which may not occur naturally.

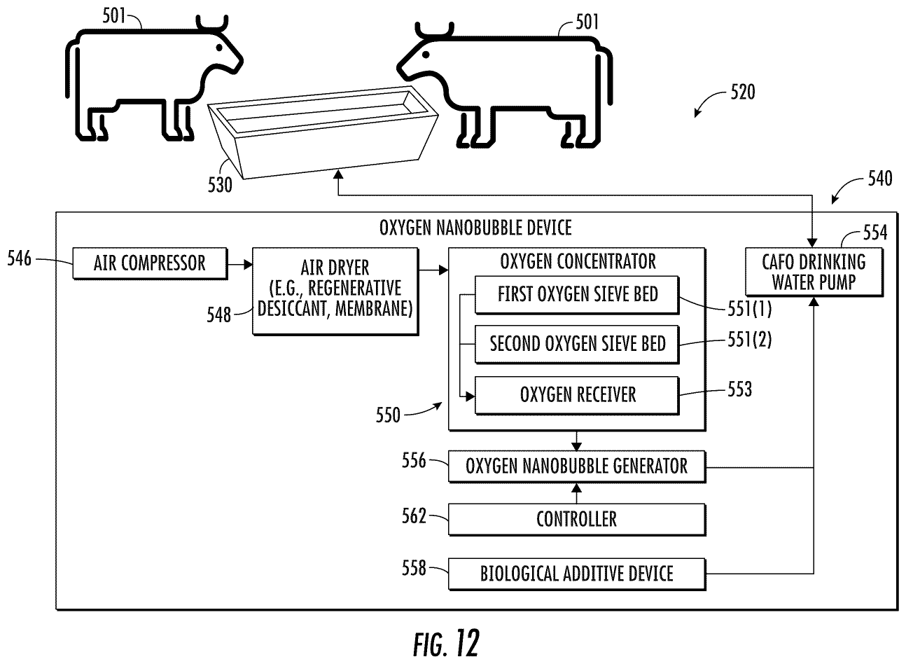

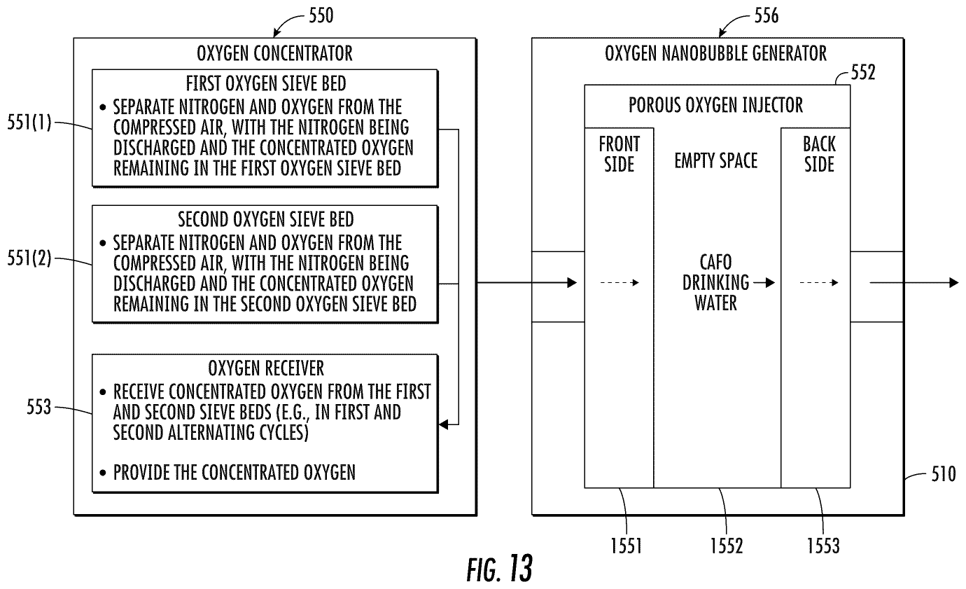

Referring now to FIGS. 12-13, another embodiment may be particularly advantageous in a concentrated animal feeding operation (CAFO). A CAFO system 520 includes a CAFO drinking water source 530. The CAFO drinking water source 530 may be in the form of a trough, as illustrated, for example, and for feeding cattle 501. In another embodiment, for example, the CAFO drinking water source 530 may be in the form of a water cup and pipeline system, which may be particularly useful for providing water to chickens. Of course, the CAFO drinking water source 530 may be in the form of another type of water source or system for feeding livestock or animals.

The CAFO system 520 also includes an oxygen nanobubble device 540. The oxygen nanobubble device 540 includes an air compressor 546 that generates compressed air. An air dryer 548 is downstream from the air compressor 546. The air dryer 548 may be in the form of a regenerative desiccant dryer, for example, or a membrane dryer.

The oxygen nanobubble device 540 also includes an oxygen concentrator 550 similar to that described above and that separates nitrogen and oxygen from the compressed air. More particularly, the oxygen concentrator 550 includes first and second oxygen sieve beds 551(1), 551(2) to separate the nitrogen and oxygen from the compressed air, as described above. The nitrogen is discharged, for example, via an exhaust device (not shown). Concentrated oxygen remains in the first and second oxygen sieve beds 551(1), 551(2).

An oxygen receiver 553 receives the concentrated oxygen from the first and second oxygen sieve beds 551(1), 551(2), as described above. More particularly, the oxygen receiver 553 receives concentrated oxygen from the first oxygen sieve bed 551(1) in a first cycle and the concentrated oxygen from the second oxygen sieve bed 551(2) in a second cycle. The first and second cycles alternate. The oxygen receiver 553 provides the concentrated oxygen.

An oxygen nanobubble generator 556 is coupled downstream from the oxygen concentrator 550. The oxygen nanobubble generator 556, similar to the nanobubble generators described above, generates oxygen nanobubbles within the CAFO drinking water. More particularly, a CAFO drinking water pump 554 operates to pump the CAFO drinking water from the CAFO drinking water source 530 through the oxygen nanobubble generator 556, and the oxygen nanobubbles may be generated as the CAFO drinking water is pumped through the oxygen nanobubble generator.

A biological additive device 558, as described above, may be coupled to the oxygen nanobubble generator 556 to permit addition of one or more biological additives into the CAFO drinking water. A controller 562 cooperates with the oxygen nanobubble generator 556 to also control an amount of oxygen injected into the CAFO drinking water. For example, the controller 556 may be operated to achieve a desired oxygen nanobubble concentration within a range of 300-400 million/ml, for example.

The oxygen nanobubble device 556 includes a generator housing 510 and a porous oxygen injector 552. The porous oxygen injector 552 extends across a CAFO drinking water passageway through the generator housing 510 to generate the oxygen nanobubbles. More particularly, the porous oxygen injector 552 includes a front side and a back side 1551, 1553 with an empty space 1552 formed therebetween. The empty space 1552 receives the concentrated oxygen from the oxygen concentrator 550. Further details of the oxygen injector 552 are described above with respect to FIGS. 6 and 7.

As will be appreciated by those skilled in the art, as it relates to CAFO operations, oxygenated CAFO drinking water enhances digestion and nutrient absorption, which may lead to healthier digestion. Healthier digestion may result in better feed conversion and weight gain. Oxygenated CAFO drinking water reduces pathogen growth as beneficial bacteria generally thrive with increased oxygen suppressing harmful pathogens.

The CAFO system 520 may also create a metabolic process of competitive exclusion. The rumen's PH balance, crucial for microbial activity, may be maintained and supported. Oxygen levels in the rumen and intestines may be increased, which reduces the occurrence of bloating—the excessive accumulation of gas. Oxygenated CAFO drinking water may also prevent stagnation and promote aerobic conditions in the water.

In particular, oxygenated CAFO drinking water may play a crucial role in metabolic processes within an animal. Oxygen accelerates the activity of digestive enzymes in the stomach and intestines. These enzymes breakdown feed components, aiding in nutrient absorption. Oxygen also enhances the growth of the beneficial gut microbiota in the rumen and intestines contributing to better digestion. Oxygen may also help detoxify harmful compounds like ammonia produced during digestion. Oxygen may also support immune cells, enhancing the ability to fight infections and maintain gut health.

A corresponding method aspect is directed to a method of treating a concentrated animal feeding operation (CAFO). The method includes generating compressed air using an air compressor 546 and drying the compressed air using an air dryer 548 coupled downstream from the air compressor. The method also includes generating concentrated oxygen using an oxygen concentrator 550 coupled downstream from the air dryer 548 and pumping CAFO drinking water using a CAFO drinking water pump 554 coupled to a CAFO drinking water source 530. The method further includes generating oxygen nanobubbles within the CAFO drinking water using an oxygen nanobubble generator 556 coupled downstream from the CAFO drinking water pump 554 and coupled to the oxygen concentrator 550.

Generating concentrated oxygen using the oxygen concentrator 550 may include separating nitrogen and oxygen from the compressed air received from the air dryer 548 using a first oxygen sieve bed 551(1), with the nitrogen being discharged and concentrated oxygen remaining in the first oxygen sieve bed. Generating concentrated oxygen using the oxygen concentrator 550 may also include separating nitrogen and oxygen from the compressed air received from the air dryer 548 using a second oxygen sieve bed 551(2), with the nitrogen being discharged and concentrated oxygen remaining in the second oxygen sieve bed, and receiving the concentrated oxygen from the first and second oxygen sieve beds using an oxygen receiver 553 and providing the concentrated oxygen, for example.

Receiving the concentrated oxygen using the oxygen receiver 553 may include receiving the concentrated oxygen from the first oxygen sieve bed 551(1) in a first cycle and the concentrated oxygen from the second oxygen sieve bed 551(2) in a second cycle, with the first and second cycles alternating. The method may also include adjusting flow of the concentrated oxygen to the oxygen nanobubble generator 556 using a controller 562, for example.

The oxygen nanobubbles may have a concentration within a range of 300-400 million/ml, for example. Of course, the concentration may be within another range, for example 250-600 million/ml. In embodiments, the concentration may be variable or not fixed. The air dryer 548 may include one of a regenerative desiccant air dryer system and a membrane dryer system. The method may include supplying at least one biological additive within the CAFO drinking water.

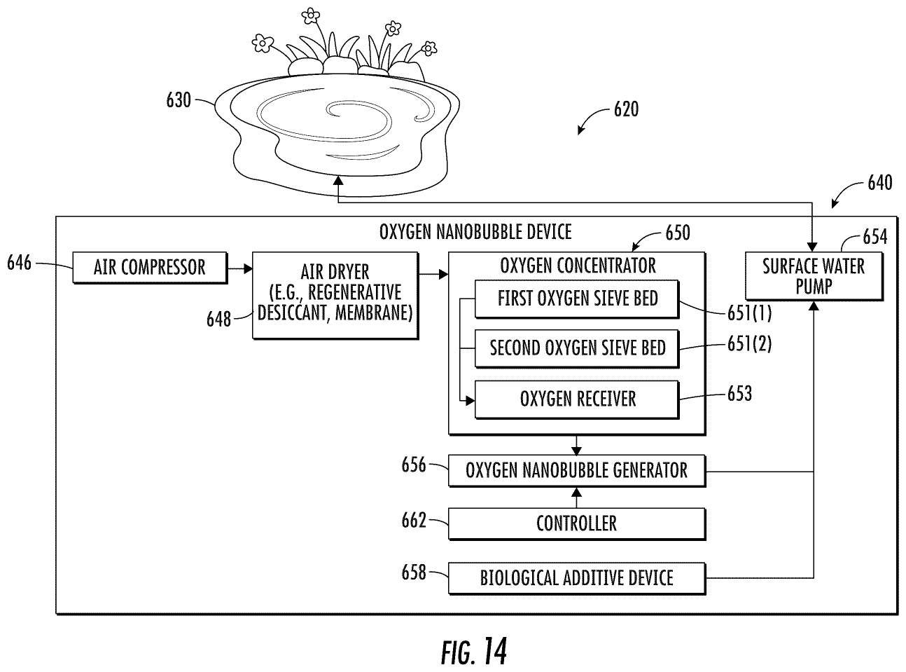

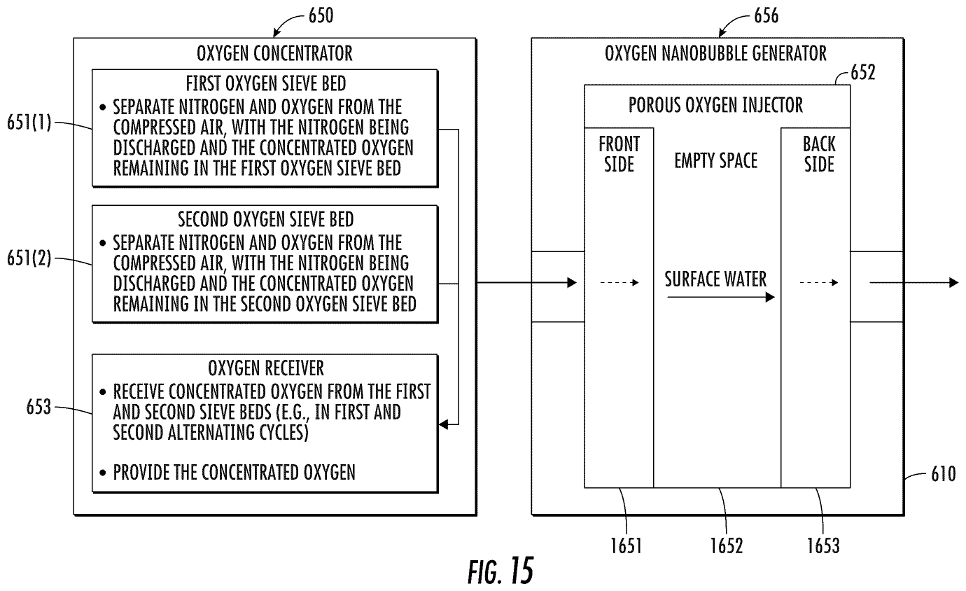

Referring now to FIGS. 14-15, another embodiment may be particularly advantageous for surface water treatment. A surface water treatment system 620 includes a surface water source 630. The surface water source 630 may be any one of a pond, lake, river, stream, or canal, for example.

The surface water treatment system 620 also includes an oxygen nanobubble device 640. The oxygen nanobubble device 640 includes an air compressor 646 that generates compressed air. An air dryer 648 is downstream from the air compressor 646. The air dryer 648 may be in the form of a regenerative desiccant dryer, for example, or a membrane dryer.

The oxygen nanobubble device 640 also includes an oxygen concentrator 650 similar to that described above and that separates nitrogen and oxygen from the compressed air. More particularly, the oxygen concentrator 650 includes first and second oxygen sieve beds 651(1), 651(2) to separate the nitrogen and oxygen from the compressed air, as described above. The nitrogen is discharged, for example, via an exhaust device (not shown). Concentrated oxygen remains in the first and second oxygen sieve beds 651(1), 651(2).

An oxygen receiver 653 receives the concentrated oxygen from the first and second oxygen sieve beds 651(1), 651(2), as described above. More particularly, the oxygen receiver 653 receives concentrated oxygen from the first oxygen sieve bed 651(1) in a first cycle and the concentrated oxygen from the second oxygen sieve bed 651(2) in a second cycle. The first and second cycles alternate. The oxygen receiver 653 provides the concentrated oxygen.

An oxygen nanobubble generator 656 is coupled downstream from the oxygen concentrator 650. The oxygen nanobubble generator 656, similar to the nanobubble generators described above, generates oxygen nanobubbles within the surface water. More particularly, a recirculating surface water pump 654 operates to pump the surface water from the surface water source 630 through the oxygen nanobubble generator 656, and the oxygen nanobubbles may be generated as the surface water is pumped through the oxygen nanobubble generator.

A biological additive device 658, as described above, may be coupled to the oxygen nanobubble generator 656 to permit addition of one or more biological additive into the surface water. A controller 662 cooperates with the oxygen nanobubble generator 656 to also control an amount of oxygen injected into the surface water. For example, the controller 656 may be operated to achieve a desired oxygen nanobubble concentration within a range of 300-400 million/ml, for example.

The oxygen nanobubble device 656 includes a generator housing 610 and a porous oxygen injector 652. The porous oxygen injector 652 extends across a surface water passageway through the generator housing 610 to generate the oxygen nanobubbles. More particularly, the porous oxygen injector 652 includes a front side and a back side 1651, 1653 with an empty space 1652 formed therebetween. The empty space 1652 receives the concentrated oxygen from the oxygen concentrator 650. Further details of the oxygen injector 652 are described above with respect to FIGS. 6 and 7.

The surface water treatment system 620 may be particularly useful for remediation of lakes, ponds, or other bodies of water, for example. For example, extreme fertilization may lead to a lake having an unhealthy pH level (e.g., 1.2 or below). The surface water treatment system 620 may be used to add bacteria in stages that, with increased level of oxygen, may increase the pH levels up to a neutral level, for example, suitable for human consumption. Where a surface water source 630 includes oil encapsulated minerals, the oil may be “eaten” in an accelerated fashion by the bacteria such that the minerals fall as solids, and the solids may be removed through a solid separation process.

Additionally, the use of oxygen nanobubbles permits the transfer of gas at a relatively high rate of efficiency. The oxygen nanobubbles may also promote the stability of the oxygen, allowing gas to penetrate the sediment layer and throughout the water column. Microorganisms in the muck receive more oxygen and this helps create an environment more conducive to muck digestion.

The oxygen provided by the surface water treatment system 620 may also stimulate the growth and activity of aerobic microorganisms that digest organic matter in the muck. This helps to increase the rate of muck digestion and reduce muck accumulation in the lake or pond. For example, when muck accumulates at the bottom of a lake or pond, the muck can become unstable and easily disturbed. This may lead to sediment resuspension, which can release nutrients and other pollutants into the water column. By increasing muck digestion, the oxygen nanobubbles can help to reduce muck accumulation and stabilize the sediment at the bottom of the lake or pond, which can reduce sediment resuspension.

A corresponding method aspect is directed to a method of treating surface water. The method includes generating compressed air using an air compressor 646, drying the compressed air using an air dryer 648 coupled downstream from the air compressor, and generating concentrated oxygen using an oxygen concentrator 650 coupled downstream from the air dryer. The method also includes recirculating the surface water using a recirculating surface water pump 654 coupled to a surface water source 630, and generating oxygen nanobubbles within the surface water using an oxygen nanobubble generator 656 coupled downstream from the recirculating surface water pump 654 and coupled to the oxygen concentrator 650.

Receiving the concentrated oxygen using the oxygen receiver 653 may include receiving the concentrated oxygen from the first oxygen sieve bed 651(1) in a first cycle and the concentrated oxygen from the second oxygen sieve bed 651(2) in a second cycle, with the first and second cycles alternating, for example. The method may also include adjusting flow of the concentrated oxygen to the oxygen nanobubble generator 656 using a controller 662.

The oxygen nanobubbles may have a concentration within a range of 300-400 million/ml, for example. Of course, the concentration may be within another range, for example 250-600 million/ml. In embodiments, the concentration may be variable or not fixed. The air dryer 648 may include one of a regenerative desiccant air dryer system and a membrane dryer system. The method also includes supplying at least one biological additive within the surface water, for example.

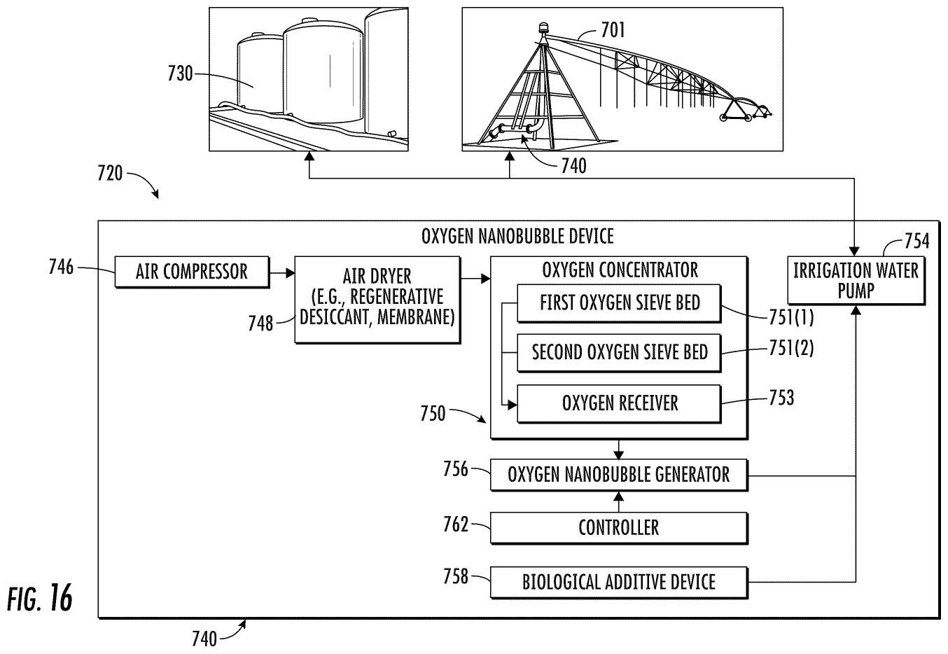

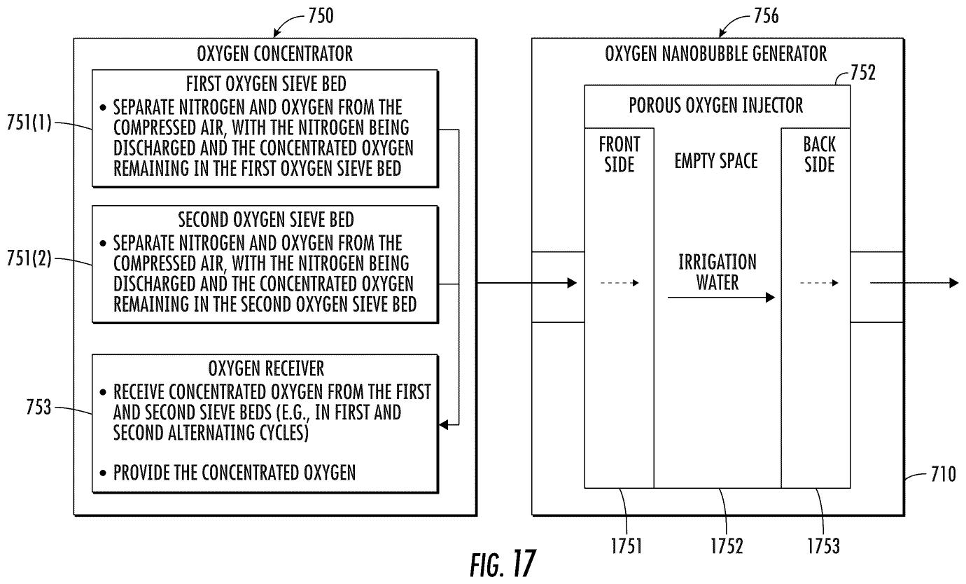

Referring now to FIGS. 16-17, another embodiment may be particularly advantageous for irrigation for an agricultural area. An irrigation system 720 includes an irrigation water source 730 for an agricultural area. The irrigation water source 730 may be a well, silo, or irrigation drafting source, such as, a lake, pond or canal, for example, and may be coupled to irrigation equipment 701 for an agricultural area. The agricultural area may include crops, trees, plants, flowers, ornamentals, lawns, gardens, shrubbery, fields, etc.

The irrigation system 720 also includes an oxygen nanobubble device 740. The oxygen nanobubble device 740 may be inline in the irrigation water flow to the irrigation equipment 701, as illustrated. The oxygen nanobubble device 740 includes an air compressor 746 that generates compressed air. An air dryer 748 is downstream from the air compressor 746. The air dryer 748 may be in the form of a regenerative desiccant dryer, for example, or a membrane dryer.

The oxygen nanobubble device 740 also includes an oxygen concentrator 750 similar to that described above and that separates nitrogen and oxygen from the compressed air. More particularly, the oxygen concentrator 750 includes first and second oxygen sieve beds 751(1), 751(2) to separate the nitrogen and oxygen from the compressed air, as described above. The nitrogen is discharged, for example, via an exhaust device (not shown). Concentrated oxygen remains in the first and second oxygen sieve beds 751(1), 751(2).

An oxygen receiver 753 receives the concentrated oxygen from the first and second oxygen sieve beds 751(1), 751(2), as described above. More particularly, the oxygen receiver 753 receives concentrated oxygen from the first oxygen sieve bed 751(1) in a first cycle and the concentrated oxygen from the second oxygen sieve bed 751(2) in a second cycle. The first and second cycles alternate. The oxygen receiver 753 provides the concentrated oxygen.

An oxygen nanobubble generator 756 is coupled downstream from the oxygen concentrator 750. The oxygen nanobubble generator 756, similar to the nanobubble generators described above, generates oxygen nanobubbles within the irrigation water. More particularly, an irrigation water source pump 754 operates to pump the irrigation water from the irrigation water source 730 through the oxygen nanobubble generator 756, and the oxygen nanobubbles may be generated as the irrigation water is pumped through the oxygen nanobubble generator.

A biological additive device 758, as described above, may be coupled to the oxygen nanobubble generator 756 to permit addition of one or more biological additives into the irrigation water. A controller 762 cooperates with the oxygen nanobubble generator 756 to also control an amount of oxygen injected into the irrigation water. For example, the controller 762 may be operated to achieve a desired oxygen nanobubble concentration within a range of 300-400 million/ml, for example.

The oxygen nanobubble generator 756 includes a generator housing 710 and a porous oxygen injector 752. The porous oxygen injector 752 extends across an irrigation water passageway through the generator housing 710 to generate the oxygen nanobubbles. More particularly, the porous oxygen injector 752 includes a front side and a back side 1751, 1753 with an empty space 1752 formed therebetween. The empty space 1752 receives the concentrated oxygen from the oxygen concentrator 750. Further details of the oxygen injector 752 are described above with respect to FIGS. 6 and 7.

The irrigation system 720 may be particularly useful for increasing efficiency of plant or crop growth, for example. As will be appreciated by those skilled in the art, efficient water infiltration to the root zone is highly desirable for high rates of water, nutrient and oxygen uptake by root cells. The irrigation system 720 may permit higher rates of plant growth and higher yields by increasing the efficiency. The oxygen nanobubbles improve water infiltration by reducing surface tension.

Root colonizing bacteria form many symbiotic relationships with plants. For example, endorhizosphere operate in the roots, rhizoplane operates in the root surface, ectorhizosphere operates around the roots, and phyllosphere colonizes on the leaf surfaces. The colonizing bacteria produce and secrete compounds that are directly and indirectly involved in promoting plant growth and crop development. The irrigation system 720 advantageously, by way of the oxygen nanobubbles, promotes operation of these bacteria and reduces irrigation water surface tension. Accordingly plant health may be improved, disease pressure may be reduced, and yield may be boosted. Moreover, at least some of the advantages and benefits of the surface water treatment system 620, described above, may be applicable to the irrigation system 720.

A corresponding method aspect is directed to a method of treating irrigation water. The method includes generating compressed air using an air compressor 746, drying the compressed air using an air dryer 748 coupled downstream from the air compressor, and generating concentrated oxygen using an oxygen concentrator 750 coupled downstream from the air dryer. The method also includes pumping irrigation water using an irrigation water source pump 754 coupled to an irrigation water source 730. The method further includes generating oxygen nanobubbles within the irrigation water using an oxygen nanobubble generator 756 coupled downstream from the irrigation water source pump 754 and coupled to the oxygen concentrator 750.

Generating concentrated oxygen using the oxygen concentrator 750 includes separating nitrogen and oxygen from the compressed air received from the air dryer 748 using a first oxygen sieve bed 751(1), with the nitrogen being discharged and concentrated oxygen remaining in the first oxygen sieve bed. Generating concentrated oxygen using the oxygen concentrator 750 also includes separating nitrogen and oxygen from the compressed air received from the air dryer 748 using a second oxygen sieve bed 751(2), with the nitrogen being discharged and concentrated oxygen remaining in the second oxygen sieve bed and receiving the concentrated oxygen from the first and second oxygen sieve beds using an oxygen receiver 753 and providing the concentrated oxygen.

Receiving the concentrated oxygen using the oxygen receiver 753 includes receiving the concentrated oxygen from the first oxygen sieve bed 751(1) in a first cycle and the concentrated oxygen from the second oxygen sieve bed 751(2) in a second cycle, with the first and second cycles alternating. The method also includes adjusting flow of the concentrated oxygen to the oxygen nanobubble generator 756 using a controller 762, for example.

The oxygen nanobubbles may have a concentration within a range of 300-400 million/ml, for example. The air dryer 748 may include one of a regenerative desiccant air dryer system and a membrane dryer system. The method may include supplying at least one biological additive within the irrigation water, for example.

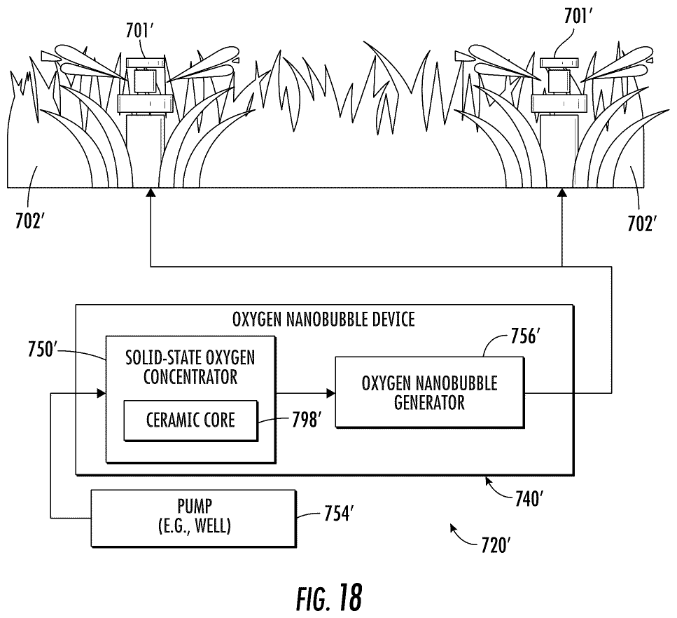

Referring now to FIG. 18, in some embodiments, for example, where a more compact or more portable system is desired, the oxygen concentrator may be in the form of a solid-state oxygen concentrator 750′. An exemplary solid-state oxygen concentrator 750′ may include a ceramic core 798′, for example, that ionizes oxygen atoms from the air. One such solid-state oxygen concentrator 750′ is the ION Ionic Oxygen Generator available from Novair of Roissy-en-France, France. Those skilled in the art will appreciate that by using a solid-state oxygen concentrator 750′ as described herein, a compressor and an air dryer may not be included within the system.

With respect to the exemplary applications described herein, the use of a solid-state oxygen concentrator 750′ may be desirable when the irrigation system 720′ is used in a residential or home setting with the agricultural area including a lawn 702′ and yard trees and shrubbery and the treated liquid or water being provided through irrigation equipment or sprinkler heads 701′.

Since the solid-state oxygen concentrator 750′ operates without a compressor and air dryer that are included in the embodiments described above with the oxygen nanobubble device, much less noise may be generated, and power may be supplied by mains power (e.g., residential mains power) making it desirable for home irrigation. The smaller size may also make the oxygen nanobubble device 740′, including the oxygen nanobubble generator 756′ able to be coupled adjacent a home irrigation controller or liquid pump 754′ (e.g., well pump), for example. Accordingly, a reduced amount of home fertilizer may be desirable and runoff from these fertilizers may be reduced. Other and/or additional components used in any of the embodiments described above may be used in the present embodiments, for example, a nitrogen nanobubble generator and/or a biological additive device. A corresponding method may be directed to a method of treating irrigation water using the drinking water treatment system 720′ described herein including the solid-state oxygen concentrator 750′.

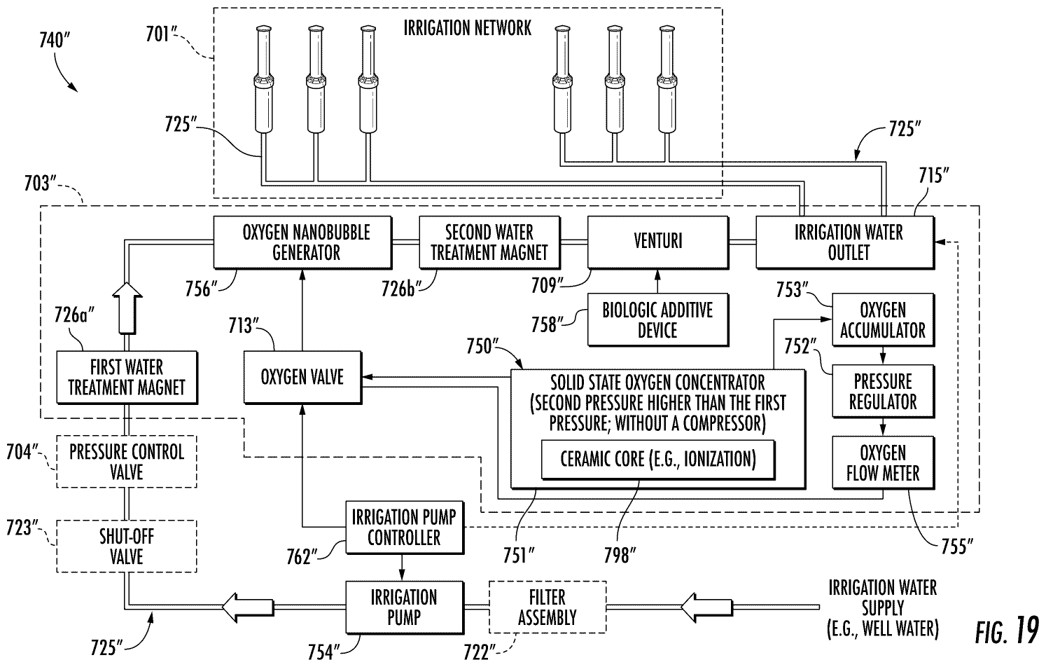

Referring now to FIG. 19, another embodiment of an irrigation water treatment device 740″ will now be described. The irrigation water treatment device 740″ includes a housing 703″. An oxygen nanobubble generator 756″ is carried by the housing 703″. The oxygen nanobubble generator 756″ is coupled downstream from an irrigation water supply for an irrigation area. The oxygen nanobubble generator 756″ is similar to the oxygen nanobubble generator described above. The oxygen nanobubble generator 756″ may generate an oxygen concentration within a range of 300-400 million/ml., as will be appreciated by those skilled in the art and described in detail above.

The irrigation water supply may be irrigation water provided from a well, silo, or irrigation drafting source, such as, a lake, pond or canal, for example. An exemplary irrigation area may include crops, trees, plants, flowers, ornamentals, lawns, gardens, shrubbery, fields, etc. The irrigation water supply is provided at a first pressure. For example, an irrigation pump 754′ may be coupled to the irrigation water supply. The irrigation pump 754″ may be adjusted and operate at the first pressure, for example, between 40-70 psi. An optional filter assembly 722″ may be coupled upstream from the irrigation pump 754″, for example, to filter debris and/or sediment from the irrigation water supply, particularly when the irrigation water supply includes well water.

An irrigation pump controller 762″ is coupled to the irrigation pump 754″ to selectively control operation of the irrigation pump. The irrigation pump controller 762″ may be in the form of a controller that includes circuitry to permit scheduling by time and irrigation zone of operation of irrigation equipment that defines an irrigation network 701″.

A shut-off valve 723″ may also optionally be coupled downstream of the irrigation pump 754″. An optional pressure control valve 704″ may also be coupled downstream from the shut-off valve 723″. In other words, the shut-off valve 723″ and the pressure control valve 704″ are coupled between the irrigation pump 754″ and the oxygen nanobubble generator 756″.

A solid-state oxygen concentrator 750″ is carried by the housing 703″ and coupled to the oxygen nanobubble generator 756″. The solid-state oxygen concentrator 750″ supplies an oxygen stream to the oxygen nanobubble generator 756″ at a second pressure higher than the first pressure (i.e., higher than the irrigation water supply). As a solid-state oxygen concentrator 750″, the second pressure is generated without a compressor and by way of a ceramic core 798″ (e.g. a ceramic wafer stack). The ceramic core 798″ is carried by a concentrator housing 751″. The ceramic core 798″ ionizes air, that, through attraction, flows (e.g., is pulled) through the ceramic core. The air flowing through the ceramic core 798″ may reach a relatively high temperature, for example, 900° F. The relatively high heat causes an increase in pressure, for example, upwards of 150 psi.

An oxygen valve 713″, for example, in the form of an oxygen solenoid, may be coupled between the solid-state oxygen concentrator 750″ and the irrigation pump controller 762″. In addition to selectively operating the irrigation pump 754″, the irrigation pump controller 762″ may additionally selectively operate the oxygen valve 713″, the oxygen nanobubble generator 756″, and the solid-state oxygen concentrator 750″, for example, so that upon desired operation of the irrigation network 701″, the irrigation pump, the oxygen nanobubble generator, and the solid-state oxygen concentrator are operated.

An oxygen accumulator 753″, for example, in the form of an oxygen storage tank is coupled downstream from the solid-state oxygen concentrator 750″. A pressure regulator 752″ may be coupled downstream from the oxygen accumulator 753″. An optional oxygen flow meter 755′ may be coupled to the pressure regulator 752″. In an embodiment, the oxygen accumulator 753″, the pressure regulator 752″, and/or oxygen flow meter 755″ may be carried by the concentrator housing 751″.

A biological additive device 758″, as described above, is carried by the housing 703″. The biological additive device 758″ may be coupled downstream from the oxygen nanobubble generator 756″ via a venturi 709″. The biological additive device 758″ may cooperate with the venturi 709″ to permit addition of one or more biological additives into the irrigation water, as described above.

An irrigation water outlet 715″ is also carried by the housing 703″. The irrigation water outlet 715″ is coupled downstream from the oxygen nanobubble generator 756″ and supplies irrigation water to the irrigation network 701″. The irrigation water outlet 715″ may include one or more solenoid valves or an indexing valve, for example, to selectively control the output of the irrigation water within the irrigation network 701″.

The irrigation water treatment device 740″ includes a water piping arrangement 725″ carried by the housing 703″. The water piping arrangement 725″ is coupled to the oxygen nanobubble generator 756″ and the irrigation water outlet 715″. In other words, the water piping arrangement 725″ includes pipes, flexible and/or rigid that permit the drinking water flow as described above and from the irrigation water supply (e.g., the well water) to the irrigation water outlet 715″.

First and second irrigation water treatment magnets 726a″, 726b″ are associated with the water piping arrangement 725″. More particularly, the first irrigation water treatment magnet 726a″ may be toroidal and surround a segment of the water piping arrangement 725″ between the pressure control valve 704″ and the oxygen nanobubble generator 756″. The second irrigation water treatment magnet 726b″ may also be toroidal and surround a segment of the water piping arrangement 725″ between the oxygen nanobubble generator 756″ and the venturi 709″ or irrigation water outlet 715″. Each irrigation water treatment magnet 726a″, 726b″ may be an electromagnet or a permanent magnet. The irrigation water treatment magnets 726a″, 726b″ may include neodymium, for example. As will be appreciated by those skilled in the art, placement of the first and second irrigation water treatment magnets 726a″, 726b″ may be particularly advantageous for further treatment of the irrigation water, the effects of which will be appreciated by those skilled in the art. The size and type of the irrigation water treatment magnets 726a″, 726b″ may be adjusted to achieve a desired field strength, for example, based upon location. In an embodiment, the irrigation water treatment magnets 726a″, 726b″ may be coupled to a controller to apply a varying or to change the magnetic field. There may be any number of irrigation water treatment magnets 726a″, 726b″.

A method aspect is directed to a method of treating irrigation water. The method includes operating an oxygen nanobubble generator 756″ carried by a housing 703″ and coupled downstream from an irrigation water supply for an irrigation area and having a first pressure. The method also includes operating a solid-state oxygen concentrator 750″ carried by the housing 703″ and supplying an oxygen stream to the oxygen nanobubble generator 756″ at a second pressure higher than the first pressure so that oxygenated irrigation water is provided to a downstream irrigation water outlet 715″ carried by the housing. The method also includes operating a biological additive device 758″ carried by the housing 703″ for the irrigation water.

Operating the solid-state oxygen concentrator 750″ may include operating the solid-state oxygen concentrator to generate the second pressure without a compressor. Operating the solid-state oxygen concentrator 750″ includes operating the solid-state oxygen concentrator to ionize air flowing through a ceramic core 798″ carried by a concentrator housing 751″ .

The method may also include operating an oxygen accumulator 753″ coupled downstream from the solid-state oxygen concentrator 750″, and operating a pressure regulator 752″ coupled downstream from the oxygen accumulator. Operating the oxygen nanobubble generator 756″ includes operating the nanobubble generator based upon an irrigation controller. Operating the oxygen nanobubble generator 756″ includes operating the oxygen nanobubble generator to generate an oxygen concentration within a range of 300-400 million/ml.

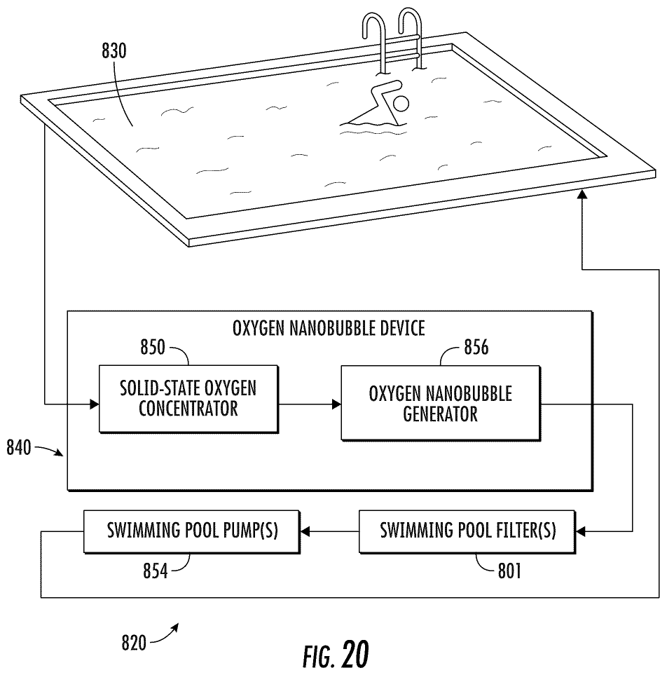

Referring now to FIG. 20, in yet another exemplary implementation using a solid-state oxygen concentrator 850, the oxygen nanobubble device 840 may be used for treatment of swimming pool water 830. The swimming pool water 830 may define the liquid or water source, and the oxygen nanobubble device 840, including the solid-state oxygen concentrator 850 and the oxygen nanobubble generator 856, may be coupled in line with swimming pool pumps and filtration. In embodiment, the pumps and filters 854, 801 may be part of the oxygen nanobubble device 840. Using the solid-state oxygen concentrator 850 may be desirable for the reasons described above—that is, less noise compact size, and ability to be powered by residential mains power, for example. Of course, swimming pool water 830 may be treated using a system that includes a non-solid-state oxygen concentrator, compressor, and air dryer. As will be appreciated by those skilled in the art, by using the water or liquid treatment system 820 for treatment of swimming pool water 830, less chemicals, such as, for example, chlorine, may be used. Other and/or additional components used in any of the embodiments described above may be used in the present embodiments to treat swimming pool water 830, for example, a nitrogen nanobubble generator and/or a biological additive device. A corresponding method may be directed to a method of treating swimming pool water 830 using the treatment system 820 described herein including the solid-state oxygen concentrator 850.

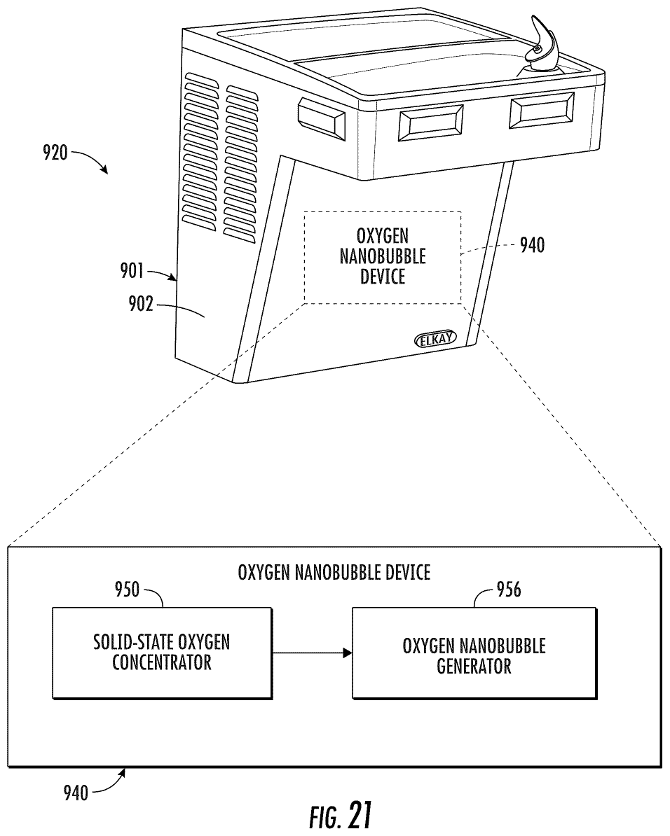

Referring now to FIG. 21, in another embodiment, a solid-state oxygen concentrator 950 may be desirable for human drinking water, for example, for use with a drinking water fountain 901. As noted above, the relatively compact size of the solid-state oxygen concentrator 950 may allow the treatment of the human drinking water, and more particularly, the oxygen nanobubble device 940 (including the solid-state oxygen concentrator and the oxygen nanobubble generator 956) to be carried within the housing 902 of the drinking water fountain 901. Power supplied to the drinking water fountain 901 may also be supplied to the oxygen nanobubble generator 956 including the solid-state oxygen concentrator 950 and the oxygen nanobubble generator.

Indeed, as will be appreciated by those skilled in the art, the liquid treatment system 920 as implemented in the drinking water fountain 901 may be particularly advantageous as providing improved quality human drinking water. Moreover, while the present liquid treatment system 920 for treating human drinking water is described as embodied in a drinking water fountain, the system may be coupled to a home water supply to provide whole house water treatment and/or to drinking water dispensing devices (e.g., a refrigerator). Other and/or additional components used in any of the embodiments described above may be used in the present embodiments to treat human drinking water, for example, a nitrogen nanobubble generator and/or a biological additive device. A corresponding method may be directed to a method of treating human drinking water using the drinking water treatment system 920 described herein including the solid-state oxygen concentrator 950.

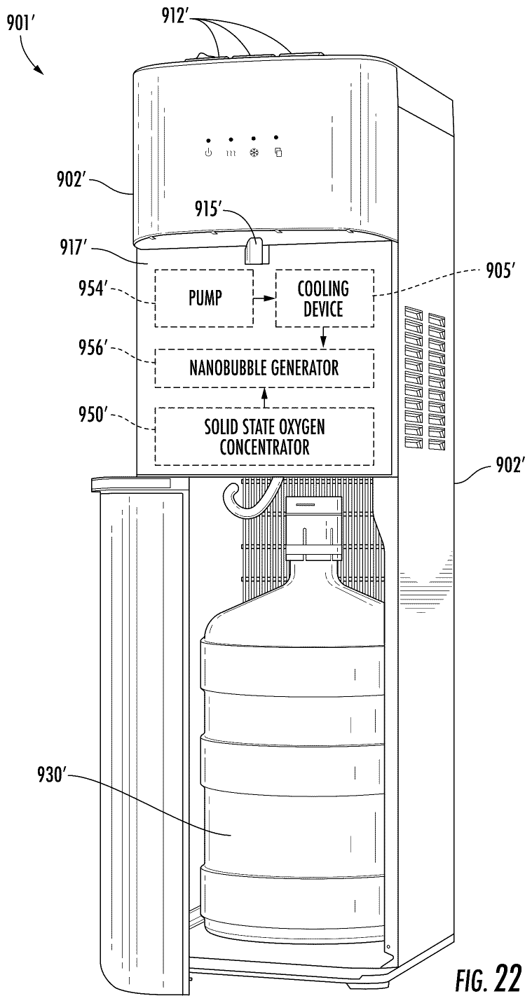

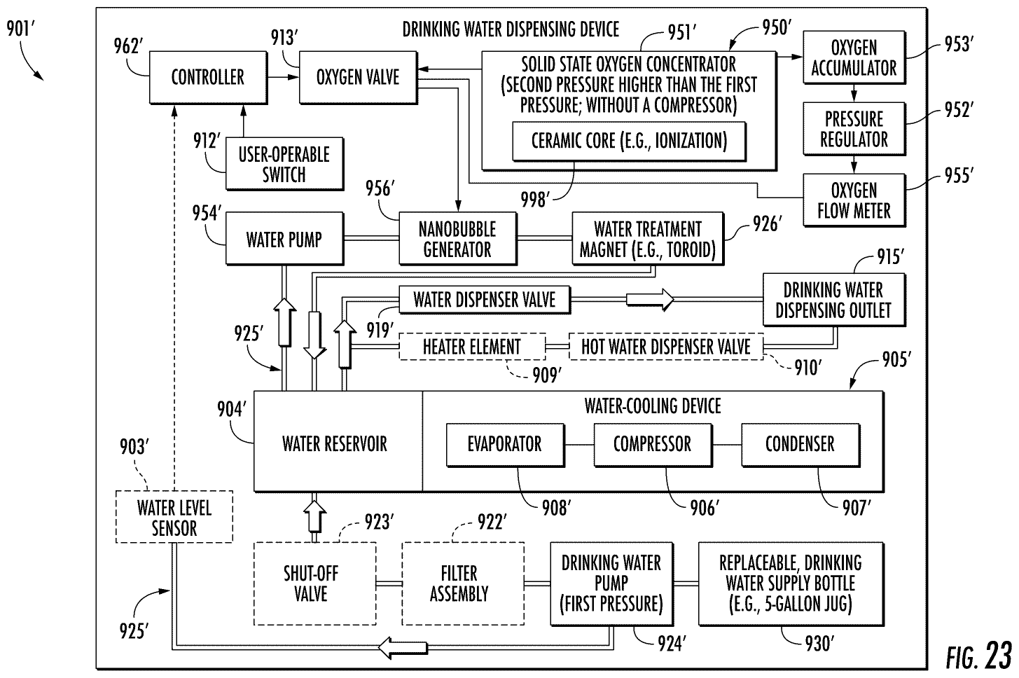

Referring now to FIGS. 22-23, further details of an exemplary drinking water dispensing device 901′ according to an embodiment will now be described. The drinking water dispensing device 901′ illustratively includes a housing 902′. The housing 902′ carries a replaceable, drinking water supply bottle 930′. The replaceable, drinking water supply bottle 930′ is illustratively in the form of a 5-gallon jug of drinking water, as may typically be associated with stand-alone drinking water dispensing devices. The replaceable, drinking water supply bottle 930′ may be considered a drinking water supply. Of course, the replaceable, drinking water supply bottle 930′ may in the form of another type of bottle, including having a different size and/or shape. The housing 902′ includes a recess 917′ therein. The recess 917′ is configured to receive a drinking water container that is aligned with a drinking water dispensing outlet 915′.

A drinking water pump 954′ is caried by the housing 902′. The drinking water pump 924′ is coupled to the replaceable, drinking water supply bottle 930′ for providing a drinking water supply stream that has a first pressure. In other words, the drinking water pump 924′ provides or outputs drinking water from the replaceable, drinking water supply bottle 930′ at a first pressure for downstream devices. The drinking water pump 924′ may be a piston pump, for example. The drinking water pump 924′ may be another type of pump, as will be appreciated by those skilled in the art.

The drinking water pump 924′ may pump the drinking water to a water reservoir 904′ via a water level sensor 903′. The water level sensor 903′ may permit water to be pumped to the water reservoir 904′ to a desired or threshold drinking water level. In other words, the water level sensor 903′ may be coupled to the drinking water pump 924′ so that pump operation is disabled or the pump is turned off when the drinking water within the water reservoir 904′ reaches the desired or threshold drinking water level.

An alternative and optional drinking water flow from the replaceable, drinking water supply bottle 930′ provides the drinking water to an downstream filter assembly 922′ coupled to the output of the drinking water pump 924′ to provide filtration to the drinking water. A shut-off valve 923′ may also optionally be coupled to the filter assembly 922′. The shut-off valve 923′ is coupled between the filter assembly 922′ and the drinking water reservoir 904′.

The drinking water dispensing device 901′ also includes a water-cooling device 905′ in the form of a refrigerant-based heat exchanger. The water-cooling device 905′ includes a compressor 906′, a condenser 907′, for example, a forced air condenser, and an evaporator 908′ (e.g., chiller/heat exchanger) arranged to define the refrigerant-based heat exchanger. In an embodiment, for example, where heated drinking water may be desired, a heater element 909′ may be coupled to the drinking water reservoir 904′. A hot water dispensing valve 910′ may be coupled downstream from the heater element 909′. The hot water dispensing valve 910′ may be a valve coupled to a user-operable switch 912′ carried by the housing 902′. The user-operable switch 912′ may control dispensing of drinking water via the drinking water dispensing outlet 915′ carried by the housing 902′. The user-operable switch 912′ may be in the form of independently operable switches to control dispensing of the drinking water as either heated, cooled, or room temperature, respectively, for example.

An oxygen nanobubble generator 956′ is carried by the housing downstream from a water pump 954′ and water-cooling device 905′. The water pump 954′ pumps water from the drinking water reservoir 904′ to the nanobubble generator 956′. Details of the nanobubble generator 956′ are described above with respect to other embodiments. The oxygen nanobubble generator 956′ may generate an oxygen concentration within a range of 300-400 million/ml., as will be appreciated by those skilled in the art and described in detail above.

A solid-state oxygen concentrator 950′ is carried by the housing 902′ and coupled to the oxygen nanobubble generator 956′. The solid-state oxygen concentrator 950′ supplies an oxygen stream to the oxygen nanobubble generator 956′ at a second pressure higher than the first pressure (i.e., from the drinking water pump 924′). As a solid-state oxygen concentrator 950′, the second pressure is generated without a compressor and by way of a ceramic core 998′ (e.g. a ceramic wafer stack). The ceramic core 998′ is carried by a concentrator housing 951′. The ceramic core 998′ ionizes air, that, through attraction, flows (e.g., is pulled) through the ceramic core. The air flowing through the ceramic core 998′ may reach a relatively high temperature, for example, 900° F. The relatively high heat causes an increase in pressure, for example, upwards of 150 psi. For reference, a typical municipal water system or pump within a drinking water dispensing device 901′ operate in the range of 40-70 psi.

An oxygen valve 913′, for example, in the form of a solenoid valve, may be coupled between the solid-state oxygen concentrator 950′ and a controller 962′. The controller 962′ is also coupled to the water pump 954′. The controller 962′ may selectively operate the water pump 954′, the oxygen valve 913′, the nanobubble generator 956′, and the solid-state oxygen concentrator 950′ based upon input, for example, from the user-operable switch 912′ so that cooled oxygenated drinking water is dispensed via the drinking water dispensing outlet 915′. More particularly, operation of user-operable switch 912′ may operate a water dispenser valve 919′ and the above devices to circulate the drinking water in the drinking water reservoir 904′ and so that the drinking water (e.g., cooled drinking water) with oxygenated nanobubbles therein is dispensed via the drinking water dispensing outlet 915′.

An oxygen accumulator 953′, for example, in the form of an oxygen storage tank may be coupled downstream from the solid-state oxygen concentrator 950′. A pressure regulator 952′ may be coupled downstream from the oxygen accumulator 953′. An optional oxygen flow meter 955′ may be coupled to the pressure regulator 952′. In an embodiment, the oxygen accumulator 953′, the pressure regulator 952′, and/or oxygen flow meter 955′ may be carried by the concentrator housing 951′.

The drinking water dispensing device 901′ includes a water piping arrangement 925′ carried by the housing 902′. The water piping arrangement 925′ extends between the replaceable, drinking water supply bottle 930′ and the drinking water dispensing outlet 915′. In other words, the water piping arrangement 925′ includes pipes, flexible and/or rigid that permit the drinking water flow as described above and from the replaceable, drinking water supply bottle 930′ to the drinking water dispensing outlet 915′ and into a drinking water container.

A water treatment magnet 926′ is associated with the water piping arrangement 925′. More particularly, the water treatment magnet 926′ may be in the form of a toroid surrounding a portion of the water piping arrangement 925′. For example, it may be particularly advantageous to place the water treatment magnet 926′ adjacent the nanobubble generator 956′, and more particularly, between the nanobubble generator and the drinking water reservoir 904′ so that the oxygenated drinking water returning to the drinking water reservoir is treated with a magnetic field. The effects of application of a magnetic field to water, for example, drinking water, will be appreciated by those skilled in the art.

The water treatment magnet 926′ may be a permanent magnet, for example, a neodymium magnet. Alternatively, the water treatment magnet 926′ may be an electromagnet. As will be appreciated by those skilled in the art, the size and type of the water treatment magnet 926′ may be adjusted to achieve a desired field strength, for example, based upon location. In an embodiment, the water treatment magnet 926′ may be coupled to a controller to apply a varying magnetic field or to change the magnetic field. There may be more than one water treatment magnet 926′, and when so, the water treatment magnets may be positioned around the housing 902′, associated with different device, or spaced apart the water piping arrangement 925′.

A method aspect is directed to a method of dispensing drinking water. The method includes operating an oxygen nanobubble generator 956′ carried by the housing 902′ and coupled downstream from a water-cooling device 905′. The water-cooling device 905′ is for cooling drinking water pumped by a drinking water pump 954′ from to a replaceable, drinking water supply bottle 930′. The drinking water pump 954′ provides a drinking water supply stream having a first pressure. The method also includes operating a solid-state oxygen concentrator 950′ carried by the housing 902′ for supplying an oxygen stream to the oxygen nanobubble generator 956′ at a second pressure higher than the first pressure so that oxygenated drinking water supply is provided to a downstream drinking water dispensing outlet 915′ carried by the housing.

Operating the solid-state oxygen concentrator 950′ includes operating the solid-state oxygen concentrator to generate the second pressure without a compressor. Operating the solid-state oxygen concentrator 950′ includes operating the solid-state oxygen concentrator to ionize air flowing through a ceramic core 998′ carried by a concentrator housing 951′.

The method includes operating an oxygen accumulator 953′ coupled downstream from the solid-state oxygen concentrator 950′, and operating a pressure regulator 952′ coupled downstream from the oxygen accumulator. Operating the oxygen nanobubble generator 956′ includes operating the oxygen nanobubble generator to generate an oxygen concentration within a range of 300-400 million/ml., for example. Operating the solid-state oxygen concentrator 950′ includes operating the solid-state oxygen concentrator to dispense cooled oxygenated drinking water via the drinking water dispensing outlet 915′ based upon a user-operable switch 912′ carried by the housing 902′.

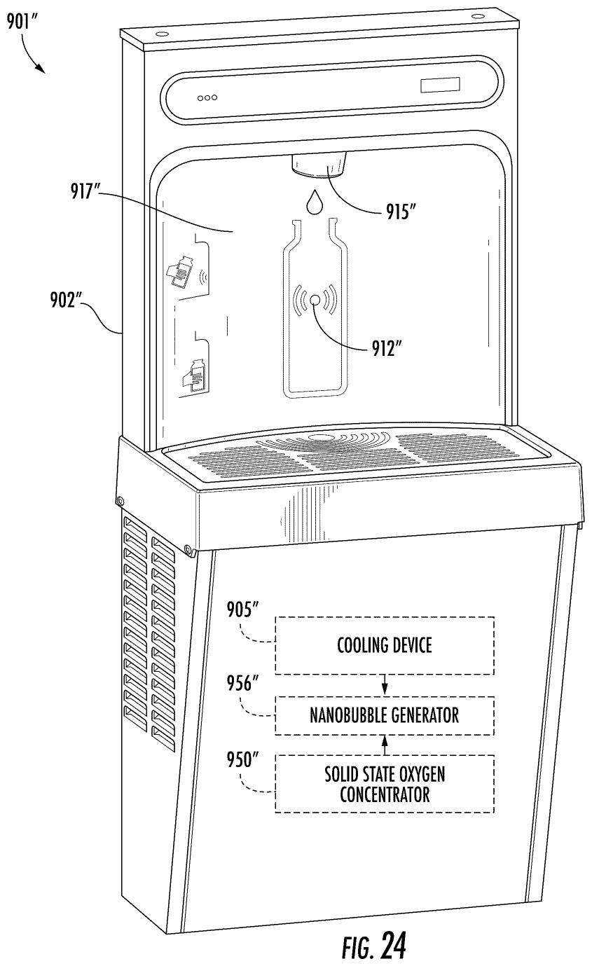

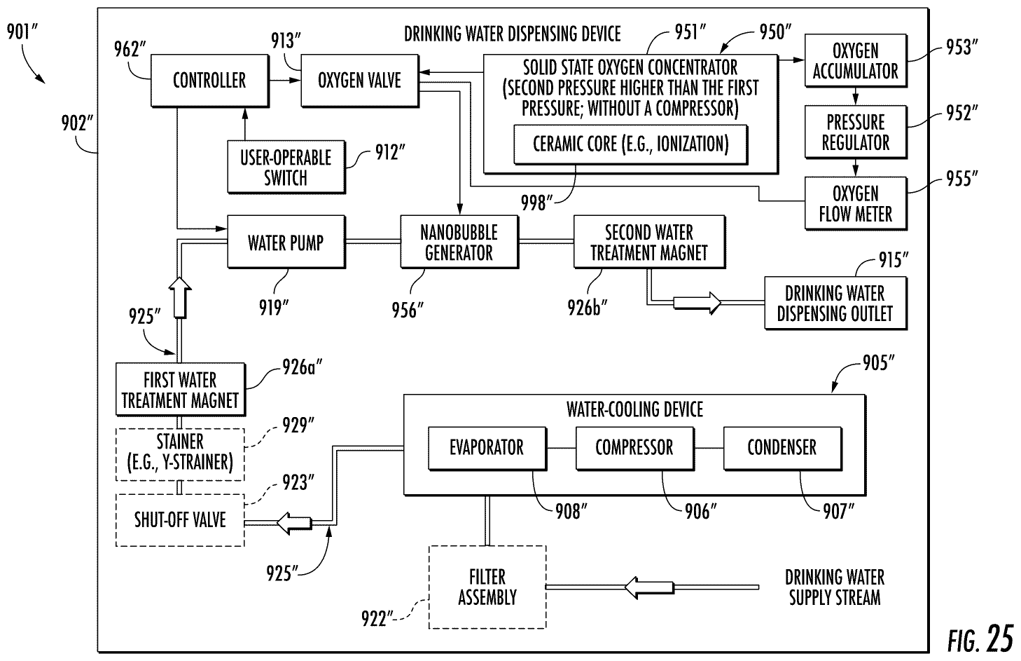

Referring now to FIGS. 24-25, further details of another exemplary drinking water dispensing device 901″ according to an embodiment will now be described. The drinking water dispensing device 901″ illustratively includes a housing 902″. The housing 902″ includes a recess 917″ therein. The recess 917″ is configured to receive a drinking water container that is aligned with a drinking water dispensing outlet 915″.

The drinking water dispensing device 901″ also includes a water-cooling device 905″ in the form of a refrigerant-based heat exchanger. The water-cooling device 905″ includes a compressor 906″, a condenser 907″, for example, a forced air condenser, and an evaporator 908″ (e. g., chiller/heat exchanger) arranged to define the refrigerant-based heat exchanger. The water-cooling device 905″ cools drinking water from water supply stream that has a first pressure. More particularly, the water-cooling device 905″ may be coupled to receive the water supply stream from a municipal or city water supply. As will be appreciated by those skilled in the art, a municipal or city water supply stream may be provided at a pressure between 40-70 psi, for example.

An optional filter assembly 922″ may be coupled upstream of the water cooling device 905″ to filter the drinking water supply stream. A shut-off valve 923″ may also optionally be coupled to the filter assembly 922′. The shut-off valve 923′ may be coupled upstream from the water-cooling device 905″. A strainer 929″, for example, in the form of a Y-Strainer, may be coupled downstream from the shut-off valve 923″.

An oxygen nanobubble generator 956″ is carried by the housing downstream from the water-cooling device 905″ . More particularly, the oxygen nanobubble generator 956″ may be coupled to an upstream water valve 919″ or water solenoid downstream from the strainer 929″ Details of the nanobubble generator 956′ are described above with respect to other embodiments. The oxygen nanobubble generator 956′ may generate an oxygen concentration within a range of 300-400 million/ml., as will be appreciated by those skilled in the art and described in detail above.

A user-operable switch 912″ carried by the housing 902″ may control dispensing of drinking water via the drinking water dispensing outlet 915″. The user-operable switch 912′ may carried by the housing 902″ within the recess 917″, for example. The user-operable switch 912″ may be in the form of a manual switch that may be activated upon user a user placing a water bottle adjacent thereto. The user-operable switch 912″ may be in the form of a sensor, for example, an optical sensor, that is activated upon placement of a water bottle or container adjacent thereto, as may occur when a user places a water bottle within the recess 917″ for filling. Of course, the user-operable switch 912″ may have another form, and there may be more than one user-operable switch, for example.

A solid-state oxygen concentrator 950″ is carried by the housing 902″ and coupled to the oxygen nanobubble generator 956″ . The solid-state oxygen concentrator 950″ supplies an oxygen stream to the oxygen stream to the oxygen nanobubble generator 956″ at a second pressure higher than the first pressure (i.e., higher than the drinking water supply stream). As a solid-state oxygen concentrator 950″, the second pressure is generated without a compressor and by way of a ceramic core 998″ (e.g. a ceramic wafer stack). The ceramic core 998″ is carried by a concentrator housing 951″. The ceramic core 998″ ionizes air, that, through attraction, flows (e.g., is pulled) through the ceramic core. The air flowing through the ceramic core 998″ may reach a relatively high temperature, for example, 900° F. The relatively high heat causes an increase in pressure, for example, upwards of 150 psi.

An oxygen valve 913″, for example, in the form of a solenoid, may be coupled between the solid-state oxygen concentrator 950″ and a controller 962″. The controller 962″ may selectively operate the water valve 919″, the oxygen valve 913″, the nanobubble generator 956′, and the solid-state oxygen concentrator 950″ based upon input, for example, from the user-operable switch 912″ so that cooled oxygenated drinking water is dispensed via the drinking water dispensing outlet 915″.

An oxygen accumulator 953″, for example, in the form of an oxygen storage tank is coupled downstream from the oxygen concentrator 950′. A pressure regulator 952″ may be coupled downstream from the oxygen accumulator 953″. An optional oxygen flow meter 955″ may be coupled to the pressure regulator 952″. In an embodiment, the oxygen accumulator 953″, the pressure regulator 952″, and/or oxygen flow meter 955″ may be carried by the concentrator housing 951″.

The drinking water dispensing device 901″ includes a water piping arrangement 925″ carried by the housing 902″. The water piping arrangement 925″ extends between the drinking water supply stream and the drinking water dispensing outlet 915″. In other words, the water piping arrangement 925″ includes pipes, flexible and/or rigid that permit the drinking water flow as described above and from the drinking water supply stream (e.g., the municipal water supply) to the drinking water dispensing outlet 915″ and into a drinking water container. First and second water treatment magnets 926a″, 926b″ are associated with the water piping arrangement 925″. More particularly, the first water treatment magnet 926a″ may be toroidal and surround a segment of the water piping arrangement 925″ between the strainer 929″ and the water valve 919″. The second water treatment magnet 926b″ may also be toroidal and surround a segment of the water piping arrangement 925″ between the nanobubble generator 956″ and the water dispensing outlet 915″. Each water treatment magnet 926a″, 926b″ may be an electromagnet or a permanent magnet. The water treatment magnets 926a″, 926b″ may include neodymium, for example. As will be appreciated by those skilled in the art, placement of the first and second water treatment magnets 926a″, 926b″may be particularly advantageous for further treatment of the drinking water, the effects of which will be appreciated by those skilled in the art. The size and type of the water treatment magnets 926a″, 926b″ may be adjusted to achieve a desired field strength, for example, based upon location. In an embodiment, the water treatment magnets 926a″, 926b″ may be coupled to a controller to apply a varying magnetic field or to change the magnetic field. There may be any number of water treatment magnets 926a″, 926b″.

A method aspect is directed to a method of dispensing drinking water. The method includes operating an oxygen nanobubble generator 956″ carried by a housing 902″ and coupled downstream from a water-cooling device 905″ carried by the housing for cooling the drinking water from a drinking water supply stream having a first pressure. The method also includes operating a solid-state oxygen concentrator 950″ carried by the housing 902″ for supplying an oxygen stream to the oxygen nanobubble generator 956″ at a second pressure higher than the first pressure so that oxygenated drinking water is provided to a downstream drinking water dispensing outlet 915″ carried by the housing.

Operating the solid-state oxygen concentrator 950″ includes operating the solid-state oxygen concentrator to generate the second pressure without a compressor. Operating the solid-state oxygen concentrator 950″ includes operating the solid-state oxygen concentrator to ionize air flowing through a ceramic core carried by a concentrator housing.

The method includes operating an oxygen accumulator 953″ coupled downstream from the solid-state oxygen concentrator 950″, and operating a pressure regulator 952″ coupled downstream from the oxygen accumulator. Operating the oxygen nanobubble generator 956″ includes operating the oxygen nanobubble generator to generate an oxygen concentration within a range of 300-400 million/ml. Operating the solid-state oxygen concentrator 950″ includes operating the solid-state oxygen concentrator to dispense cooled oxygenated drinking water via the water dispensing outlet 915″ based upon a user-operable switch 912″carried by the housing 902″.

Many modifications and other embodiments will come to the mind of one skilled in the art having the benefit of the teachings presented in the foregoing descriptions and the associated drawings. For example, while a number of horizontally oriented embodiments have been described, vertical configurations are also included. In addition, in yet other embodiments, power may be derived from a vehicle as will be appreciated by those skilled in the art. Therefore, it is understood that the foregoing is not to be limited to the example embodiments, and that modifications and other embodiments are intended to be included within the scope of the appended claims.

1. A drinking water dispensing device comprising:
a housing;
a water-cooling device carried by the housing for cooling drinking water from a drinking water supply stream having a first pressure;
an oxygen nanobubble generator carried by the housing and coupled downstream from the water-cooling device;
a solid-state oxygen concentrator carried by the housing for supplying an oxygen stream to the oxygen nanobubble generator at a second pressure higher than the first pressure; and
a drinking water dispensing outlet carried by the housing and coupled downstream from the oxygen nanobubble generator.

2. The drinking water dispensing device of claim 1 wherein the solid-state oxygen concentrator is configured to generate the second pressure without a compressor.

3. The drinking water dispensing device of claim 2 wherein the solid-state oxygen concentrator comprises a concentrator housing and a ceramic core within the concentrator housing and configured to ionize air flowing therethrough.

4. The drinking water dispensing device of claim 1 comprising:
an oxygen accumulator coupled downstream from the solid-state oxygen concentrator; and
a pressure regulator coupled downstream from the oxygen accumulator.

5. The drinking water dispensing device of claim 4 comprising an oxygen flow meter coupled downstream from the pressure regulator.

6. The drinking water dispensing device of claim 1 comprising a water piping arrangement carried by the housing and extending between the drinking water supply stream and the drinking water dispensing outlet.

7. The drinking water dispensing device of claim 6 comprising at least one water treatment magnet associated with the water piping arrangement.

8. The drinking water dispensing device of claim 1 wherein the housing has a recess therein configured to receive a drinking water container aligned with the drinking water dispensing outlet.

9. The drinking water dispensing system of claim 1 wherein the oxygen nanobubble generator is configured to generate an oxygen concentration within a range of 300-400 million/ml.

10. The drinking water dispensing device of claim 1 wherein the water-cooling device comprises a compressor, a condenser, and an evaporator arranged to define a refrigerant-based heat exchanger.

11. The drinking water dispensing device of claim 1 comprising a user-operable switch carried by the housing and configured to operate the solid-state oxygen concentrator to dispense cooled oxygenated drinking water via the drinking water dispensing outlet.

12. A drinking water dispensing device comprising:
a housing;
a water-cooling device carried by the housing for cooling drinking water from a drinking water supply stream having a first pressure;
an oxygen nanobubble generator carried by the housing and coupled downstream from the water-cooling device;
a solid-state oxygen concentrator carried by the housing for supplying an oxygen stream to the oxygen nanobubble generator at a second pressure higher than the first pressure and without a compressor.

13. The drinking water dispensing device of claim 12 wherein the solid-state oxygen concentrator comprises a concentrator housing and a ceramic core within the concentrator housing and configured to ionize air flowing therethrough.

14. The drinking water dispensing device of claim 12 comprising:
an oxygen accumulator coupled downstream from the solid-state oxygen concentrator; and
a pressure regulator coupled downstream from the oxygen accumulator.

15. The drinking water dispensing device of claim 12 wherein the oxygen nanobubble generator is configured to generate an oxygen concentration within a range of 300-400 million/ml.

16. The drinking water dispensing device of claim 12 wherein the water-cooling device comprises a compressor, a condenser, and an evaporator arranged to define a refrigerant-based heat exchanger.

17. A method of dispensing drinking water comprising:
operating an oxygen nanobubble generator carried by a housing and coupled downstream from a water-cooling device carried by the housing for cooling the drinking water from a drinking water supply stream having a first pressure; and
operating a solid-state oxygen concentrator carried by the housing for supplying an oxygen stream to the oxygen nanobubble generator at a second pressure higher than the first pressure so that oxygenated drinking water is provided to a downstream drinking water dispensing outlet carried by the housing.

18. The method of claim 17 wherein operating the solid-state oxygen concentrator comprises operating the solid-state oxygen concentrator to generate the second pressure without a compressor.

19. The method of claim 18 wherein operating the solid-state oxygen concentrator comprises operating the solid-state oxygen concentrator to ionize air flowing through a ceramic core carried by a concentrator housing.

20. The method of claim 17 comprising:
operating an oxygen accumulator coupled downstream from the solid-state oxygen concentrator; and
operating a pressure regulator coupled downstream from the oxygen accumulator.

21. The method of claim 17 wherein operating the oxygen nanobubble generator comprises operating the oxygen nanobubble generator to generate an oxygen concentration within a range of 300-400 million/ml.

22. The method of claim 17 wherein operating the solid-state oxygen concentrator comprises operating the solid-state oxygen concentrator to dispense cooled oxygenated drinking water via the water dispensing outlet based upon a user-operable switch carried by the housing.
